(19) United States
(12) Patent Application Publication
(10) Pub. No.: US 2014/0149162 A1
(43) Pub. Date: May 29, 2014

(54) Methods for tacit knowledge management and for transferring and developing tacit knowledge

(71) Applicant: Universidade Federal de Minas Gerais - UFMG, Belo Horizonte (BR)

(72) Inventors: Rodrigo Magalhaes Ribeiro, Belo Horizonte (BR); Francisco de Paula Antunes Lima, Belo Horizonte (BR); Paulo Henrique Marques da Silva, Belo Horizonte (BR)

(21) Appl. No.: 14/159,557

(22) Filed: Jan. 21, 2014

Related U.S. Application Data
(63) Continuation-in-part of application No. PCT/BR2012/000268, filed on Jul. 23, 2012.

(30) Foreign Application Priority Data
Jul. 21, 2011 (BR) PI 1103375-4
Aug. 31, 2013 (BR) 132012022017-1

(51) Int. Cl. G09B 19/00; G06Q 10/06

(52) U.S. Cl. CPC G09B 19/00; G06Q 10/063112
USPC 705/7.14; 434/219

(57) ABSTRACT

The matter addressed in the present document refers to two methodologies for Tacit Knowledge Management Levels of Similarity and Levels of Immersion. Respectively, they qualify professionals' previous experience and training systems so as to maximize the transfer of tacit knowledge. Additionally, the subject matter addressed in the present document describes a work-related training technique which is specifically directed towards the transfer and development of tacit knowledge—by means of activity analyses, elaboration of decision-making trees, creation of learning environments, introductory training and guided on-the-job training This process systematizes work training in a way that avails reduction of time spent and improvement in the content of training.

### REFERENCE TO RELATED APPLICATIONS

This application is a continuation-in-part application of International Application number PCT/BR2012/000268 filed on Jul. 23, 2012. International Application number PCT/BR2012/000268 claims priority to Brazil Patent Application number PI 11003375-4 filed on Jul. 21, 2011. This application claims priority to Brazil Patent Application number 132012022017-1 (certificate of addition) filed Aug. 31, 2013. Brazil Patent Application number PI 11003375-4, International Application number PCT/BR2012/000268, and Brazil Patent Application number 132012022017-1 are incorporated by reference herein in their entirety.

### APPLICABLE FIELD

The matter addressed in this document describes a work-related training technique which is specifically directed towards the transfer and development of tacit knowledge—by means of activity analyses, the elaboration of judgment trees, the creation of a learning environment, introductory training and guided on-the-job training This process systematizes work training in a way that avails reduction of time spent and improvement in the content of training.

The matter addressed in the present document also refers to two methodologies for Tacit Knowledge Management: Levels of Similarity and Levels of Immersion. Respectively, they qualify professionals' previous experience and training systems so as to maximize the transfer of tacit knowledge.

### BACKGROUND

Unless otherwise indicated herein, the elements described in this section are not prior art to the claims and are not admitted to be prior art by inclusion in this section.

There are two basic types of knowledge according to the literature: explicit knowledge and tacit knowledge. Explicit knowledge is regarded as the type of knowledge that can be codified into objects both human beings and machines can use. Instances of these objects are books, instruction manuals, and standard operating procedures (SOPS)—for human beings—or algorithms and computer programs—for machines. Tacit knowledge, on the other hand, is the form of knowledge that springs from human experience in work situations and cannot be fully verbalized or transposed into the form of rules that could be successfully followed by inexperienced people. Examples of tacit knowledge are: the ability to make technical judgments and some physical abilities, such as identifying whether a production process is working properly or not based only on the color of the smoke that comes out of the stack in an industrial plant.

The existence of two different types of knowledge entails the possibility of two distinct types of management: explicit and tacit knowledge management. Explicit knowledge management is known in academic literature, especially in the area of Management, simply as “knowledge management,” and its function is to amass, classify, and store all kinds of information in order to make it available through knowledge portals, intranets, and other informational tools. Therefore, this area is largely based on information technologies (IT) and presents several tools developed specifically for managing that which can be made explicit.

There are at least two problems and limitations of (explicit) knowledge management. First, it is not possible to deal with tacit knowledge by using informational tools, due to the nature of this type of knowledge. Secondly, all so-called explicit knowledge depends on tacit knowledge in order to be used appropriately. This means that people must be capable of interpreting what is written, of judging its relevance, and of applying the rules or information disclosed in the document to the matter at hand, because pieces of explicit knowledge—books, instruction manuals and operating procedures—are not of themselves explicit. (Ribeiro, R. (2007) Knowledge Transfer. Doctoral Thesis. Cardiff Cardiff University). The best example of this is illustrated by hieroglyphs that are still undeciphered: although they are “explicit”—for they have been written down—, no one can understand them. The link that allowed them to be read, that is, the tacit knowledge possessed by those peoples who made use of that form of writing, was lost in time.

Because of these problems, there is a vast array of papers published on “knowledge management” (as it is understood in Management), but not on “tacit knowledge management.” Therefore, when the terms “tacit knowledge management,” “managing tacit knowledge,” or “Tacit KM” are used in academic searches for the purpose of finding papers related to the topic (through their titles, abstracts, or text bodies), the number of papers that show up in the results are significantly smaller than when one searches for “knowledge management,” “managing knowledge,” or “explicit KM.” Table 1 gives us a general overview concerning the number of papers found in both cases, in searches done in the main journals in the field.

TABLE 1
Publications on Knowledge Management versus Tacit Knowledge
Management

| | Number of papers with | Number of papers |
|---|---|---|
| | Knowledge Management | with Tacit Knowledge |
| | in the title, | Management in the |
| Journals Searched | abstract, or text | title, abstract, or text |
| Journal of | 1380 | 13 |
| Knowledge | | |
| Management | | |
| Knowledge | 1334 | 1 |
| Management | | |
| Knowledge | 150 | 0 |
| Management for | | |
| Development Journal | | |
| Knowledge | 573 | 0 |
| Management | | |
| Research and | | |
| Practice | | |
| Knowledge | 23 | 0 |
| Management Review | | |

The difficulty in thinking about tacit knowledge management can also be observed in the vast academic discussion about the importance of tacit knowledge for the most diverse areas and organizations and in the absence of methodologies developed specifically for managing this type of knowledge. Several papers and patents that apparently deal with this matter were found, however. They shall be analyzed in the following paragraphs.

In the paper “Tacit Knowledge Management: The Role of Artifacts,” the author says (1) that tacit knowledge must be put into a manageable form by making it explicit and by setting apart the workers that possess this kind of knowledge (p. 112) and (2) that her suggestion, on the contrary, would be that tacit knowledge must be managed tacitly (p. 113). These two statements, which are central to the discussion carried out over the paper, illustrate the fact that no formal methodology for tacit knowledge management is presented there (Kreiner, Kristian (2006) “Tacit Knowledge Management: The Role of Artifacts.” Journal of Knowledge Management (6:2) pp. 112-126).

The paper entitled “The Use of Tacit Knowledge within Innovative Companies:

Knowledge Management in Innovative Enterprises” refers to tacit knowledge management, but it does not present a detailed methodology on how to put management into practice; it merely discusses the topics involved in a general manner, as promoting “socialization” (p. 136) or “brainstorming” (p. 137) to allow for the transfer of tacit knowledge and for “personal interactions” (p. 137) for the purpose of identifying tacit knowledge. Additionally, the authors mention that one way for obtaining tacit knowledge for an organization is “recruiting the right individuals with adequate education and professional experience,” but the authors do not go into detail about the analysis of the adequacy of an applicant's professional experience. The matter treated here, on the other hand, uses levels of similarity for identifying people with a specific tacit knowledge by means of a comprehensive analysis of their professional curriculum vis-à-vis the standards of similarity for their intended job, and levels of immersion, so as to connect different types of tacit knowledge and how they can be developed, thereby allowing for planning and practical action regarding the optimization of the transfer. (Alwis, Ragna Seidler-de; Hartmann, Evi. (2008) “The Use of Tacit Knowledge within Innovative Companies: Knowledge Management in Innovative Enterprises.” Journal of Knowledge Management. (12) pp. 133-147).

The article entitled “Role of Leadership in Knowledge Management: A Study” refers to the matter of leadership and its impact on knowledge management. In his text the author does refer to the “Knowledge Management Practices” developed by Maier & Mosley (2003). However, in perusing the original, one observes that it is a questionnaire about the practices of companies—using a Likert scale to ask the worker to rate from 1 (no) to 5 (excellent) presence of, for instance, the following practice in his company: “Tacit knowledge (that which workers can do but cannot express) is valued and transferred within the company.” The simple fact that a questionnaire is utilized and that in the very question the concept of tacit knowledge had to be explained demonstrates the superficiality with which the paper deals with tacit knowledge management practices (Singh, Sanjay Kumar (2008) “Role of Leadership in Knowledge Management: A Study”. Journal of Knowledge Management. (12:4) pp. 3-15).

The paper entitled “What Do We Know?” shows how our comprehension of knowledge management remains limited. For instance, the authors ask: “What is (and is not) tacit knowledge?” The methodologies for tacit knowledge management presented in this document are meant to go beyond the mere definition of this type of knowledge to its daily management in organizations (Rory, Chase L. (2008) “What Do We Know?” Journal of Knowledge Management. (11:2) pp. 1).

In the paper entitled “A Principal-Agent Model for Incentive Design in Knowledge Management”, the author states that “for sharing tacit knowledge, which cannot be expressed, it is possible to use information technology to provide the basis for creating knowledge networks” (p. 110). That does not consist of a methodology for tacit knowledge management; nevertheless, even if it did, that methodology would bear no resemblance to what is expounded in the matter addressed in the present document (Nan, Ning (2008) “A Principal-Agent Model for Incentive Design in Knowledge Management”. Journal of Knowledge Management. (12:3) pp. 101-113).

The paper entitled “Linkage between Knowledge Management and R&D Management” mentions Tacit Knowledge Management: “to the extent that tacit knowledge management, as well as sets of abilities, professional networks, and organizational memory are required, there is a need for collaborative groups, such as practice communities, so that knowledge which is difficult to make explicit can be shared and spread” (p. 139). However, a methodology for doing this management is not discussed in the paper (Park, Yongtae; Kim, Seonwoo (2005) “Linkage between Knowledge Management and R&D Management”. Journal of Knowledge Management. (9:4) pp. 33-44).

The paper entitled “Networks, Cognition and Management of Tacit Knowledge” argues that tacit knowledge management depends on knowledge network management. The authors present no methodology for such a purpose. (Augier, Mie; VendelØ, morten T (1999) “Networks, Cognition and Management of Tacit Knowledge”. Journal of Knowledge Management. (3:4) pp. 252-261).

The paper entitled “The Effect of Tacit Knowledge on Firm Performance” provides a Tacit Knowledge Index for measuring the “level of tacit knowledge within a company” (p. 148). This index measures the presence of “methods of knowledge management based on tacit knowledge . . . as the crafting abilities of masters, practice communities, and collaboration” (p. 148). However, this index does not quantify or provide an estimated quantity of tacit knowledge within a group of workers, but only the presence of collaborative methods that may lead to a greater dissemination of tacit knowledge. Thus, the index presented does not bear any similarity to what is proposed by the matter addressed in the present document. (Harlow, Harold (2008) “The Effect of Tacit Knowledge on Firm Performance”. Journal of Knowledge Management. (12:1) pp. 148-163).

The paper entitled “Tacit Knowledge Transfer and the Knowledge Disconnect” mentions tacit knowledge management twice throughout its text (pp. 9 and 15), but always as a problem that needs to be solved. In the paper's “Conclusion,” it is then said that “There is clear evidence that explicit managerial mechanisms for Tacit Knowledge Management are necessary, and such mechanisms will be different from those employed for [the management of] more explicit types of knowledge” (p. 16). The matter addressed in the present document, therefore, fills the gap identified by the authors of that paper (Foos, Ted; Schum, Gary and Rothenberg, Sandra (2008) “Tacit Knowledge Transfer and the Knowledge Disconnect”. Journal of Knowledge Management. (11:1) pp. 6-18).

PCT WO 200046721, entitled “Enterprise Value Enhancement System and Method,” is a computer program that generates questionnaires to be answered by the employees of a given company, and, from the analysis of the answers obtained, the program generates recommended solutions for raising value related to specific functions. The author reports that part of his method's success is due to a successful apprehension of tacit knowledge (on the part of the questionnaires). As can be observed, this system treats tacit knowledge as susceptible of being “apprehended” through the workers' answers to the questionnaire. However, if the workers' knowledge was verbalized and made explicit by their answers, it can no longer, by definition, be considered tacit knowledge. Furthermore, it seems important to state that the premise adopted on that patent—that tacit knowledge must be made explicit and apprehended—has no relation whatsoever with the tacit knowledge management methodologies described in the present document.

Patent US 2010036789, entitled “Software for facet classification and information management”, consists in a document classification software with a semantic layer, where the relation of structured, non-structured, and tacit information is established. Therefore, it is a product whose purposes are completely different from those of the methodology for identifying, quantifying, and distributing tacit knowledge among groups of professionals (Methodology 1). The patent also does not consist of training systems that focus on the development of tacit knowledge (Methodology 2).

Patent US 2004260714, entitled “Universal annotation management system,” is a mechanism for the retrieval of information from annotations made on computer data objects, with a view to extracting the tacit knowledge apprehended in these annotations. Therefore, it is a product that does not deal with the tacit knowledge of professional groups or with training systems.

U.S. Pat. No. 7,620,648, entitled “Universal annotation configuration and deployment,” consists in a method of configuration and implementation of a system for capturing tacit knowledge in a company. This method identifies the company's processes, the documents related to the processes, and data objects that are susceptible to be annotated as regards these processes. It is evident by this patent's premise—that it is possible to capture a company's tacit knowledge—that it has nothing to do with tacit knowledge management of people and training systems, which are the propositions of the matter here addressed.

PCT WO 0235309, entitled “System for Retrieving Personalized Relevant Knowledge for Customers and Clients”, consists in a technology for converting the content of portals into personalized content organized according to the user's goal. The proposed technology consists of a system for browsing and for guiding users, a set of knowledge structures, a framework for processing data and another for organizing knowledge-mining in favor of a vaster practice on the part of the community. It is therefore a product that deals with informational (or explicit) knowledge, and not with knowledge management by means of people and training systems.

After an analysis of the state of the art, it was observed that the methodologies of the so-called tacit knowledge management and the aforementioned patents, in actuality, consist of methodologies of information management or explicit knowledge management. In other words, those documents are based on the assumption that tacit knowledge can be made explicit and, thus, utilized by means of computers.”

The existence of two different types of knowledge entails the possibility of conducting two distinct types of training—one that focuses on teaching operating procedures, using manuals, and utilizing sets of instructions (that is, dealing with “explicit knowledge”) and is generally carried out in classrooms, and another one that is turned towards practical training, also called OJT (On-the-Job Training).

There are at least two problems or limitations with training based exclusively on “explicit knowledge.” In the first place, the so-called explicit knowledge, in all of its forms, depends on tacit knowledge if it is to be used correctly. The best example of this is hieroglyphs that are still undeciphered: although they are “explicit”—for they have been written down—no one can understand them. The link that allowed them to be read, that is, the tacit knowledge possessed by those peoples who made use of that form of writing, was lost in time. The second problem is that the “rules do not contain rules for their own application”—this is called the “regression of rules.” (Wittgenstein, L. Philosophical Investigations. Oxford: Blackwell, (1953)). This maxim indicates that people must be capable of interpreting what is written, of judging its relevance, and of applying the rule or information disclosed in the document to the situation at hand. In short, all action is situated and should therefore take into account the contextual elements, which will always require experience in order to be adequately assessed in face of the rules presented by manuals or procedures. Thus, pieces of explicit knowledge—books, manuals and standard operating procedures—are not in and of themselves explicit. (Ribeiro, R. (2007) Knowledge Transfer. Doctoral Thesis. Cardiff. Cardiff University).

Regarding on-the-job training, no literature has been found that deals with the connection between this type of training and the development of tacit knowledge. In general, there exists a vast amount of literature concerned with the execution of on-the-job training, but all training programs converge on the same central points: (1) showing how it is done; (2) explaining the main points; (3) doing it again; (4) letting apprentices try doing the job, but under supervision; (5) giving feedback; and (6) letting apprentices do the job on their own (McCord, A. Job training. In: Craig, R. 20 (Ed.). Training development handbook: a guide to human resource development. New York: McGraw-Hill, 1987, 3 ed.; Jacobs, R. L. Structured on-the-job training: unleashing employee expertise in workplace. San Francisco: Berrett-Koehler, 2003; Walter, D. Training on-the-job. Alexandria: ASTD, 2002; Rothwell, W. J.; Kazanas, H. C. Improving on-the-job training: how 25 to establish and operate a comprehensive OJT program. San Francisco: Jossey-Bass Publisher, 1994). However, such literature does not directly deal with tacit knowledge—on the other hand, a direct treatment of the subject, as will be demonstrated in the present document, allows for the creation of a training process specifically directed towards the transfer and development of tacit knowledge. Furthermore, but for a few exceptions (Ribeiro, Rodrigo (2007) Knowledge Transfer. Doctoral Thesis. Cardiff. Cardiff University; Collins, Harry. Tacit and Explicit Knowledge. Chicago: The University of Chicago Press, 2010, and Ribeiro, Rodrigo (2012a) Tacit knowledge management. Phenomenology and the Cognitive Sciences, DOI: 10.1007/s11097-011-9251-x), all that can be found in the literature is reference to a type of tacit knowledge that was defined over 45 years ago, merely as “we know more than we can tell” (Polanyi, Michael (1966). The tacit dimension. London: Routledge & Kegan Paul).

Three types of tacit knowledge can be dealt with in the training system introduced here: somatic, contingent, and collective. (Ribeiro, R (2012a) Tacit knowledge management. Phenomenology and the Cognitive Sciences, DOI: 10.1007/s11097-011-9251-x). Somatic tacit knowledge concerns the sensory and motor abilities that people develop in a given field of activity. For instance, experienced factory operators are able to identify problems with machines based only on noises, on vibration, or even on the color of the smoke that rises out from a stack. The gist of what is called “sensitive maintenance” is also based upon somatic tacit knowledge. A good maintenance inspector, for instance, is able to listen for problems with the bearing of a machine by placing a pen in his mouth or ear and touching with it the engine's bearing, much as a doctor listens for heartbeats with an stethoscope. By the same token, experienced radiologists can identify different types of problems in x-rays, while patients are only able to perceive different shades of gray.

Contingent tacit knowledge, in turn, is a type of knowledge that is tacit due to matters of technological development of a given field or to contingent matters. The best example of this are the rules embedded into daily activities, which are learned automatically, without awareness that something is being learned. One notices the existence of these rules, however, when someone breaks them.

Lastly, there is collective tacit knowledge (Collins, H. Bicycling in the moon: Collective tacit knowledge and somatic-limit tacit knowledge. Organization Studies, 28(2), pp 257-262, 2007). This type of tacit knowledge enables people to perform activities that depend on immersion in a culture (technical or not) for the successful execution of these activities. It is this type of tacit knowledge that, for instance, allows people to attain linguistic fluency in a natural language, to know how to behave in different situations, and to make “correct judgments.” (Wittgenstein, L. (1953). Philosophical investigations. Oxford: Blackwell).

Three types of judgment have been identified as essential to any activity, whether operational (shop-floor) or managerial: “similarity/difference judgment,” “relevance/irrelevance judgment,” and “risk/opportunity judgment” (Ribeiro, R Tacit knowledge management. Phenomenology and the Cognitive Sciences, DOI: 10.1007/s11097-011-9251-x; Ribeiro, Rodrigo (2012b) Levels of Immersion, Tacit Knowledge and Expertise. Phenomenology and the Cognitive Sciences, DOI: 10.1007/s11097-012-9257-z (2012)).

Being able to make judgments of similarity and difference is what allows experienced professionals to identify a problem or tendency where novices would not notice. Problems or tendencies concern differences in relation to normality, and novices do not possess the necessary experience to judge what is normal and what is different. A real example can illustrate this ability. A novice was sent to oversee the disposal of a certain material with a temperature of 650° C., who, seeing the material being correctly poured into a 6-ton ladle, informed his supervisor by radio that everything was going well. But the experienced supervisor decided to check for himself, and when he got close enough that he could see the pouring of the material, he called the novice on the radio and told him to stop pouring immediately; the material had filled the ladle up to the top, and were it not for the supervisor, it would have spilled over and caused an incident, or possibly even an accident. The reason for this was that the material was to thin and hot, therefore flowing too fast; however, the novice could not tell it was “flowing too fast”, because he had no experience of watching it “flow normally”. That is, he did not have enough experience so as to be able to identify the problem, because his knowledge was not sufficient for him to make a judgment of similarity/difference.

Collective tacit knowledge also allows those who have it to contrast between different scenarios, based on the identification of differences between scenarios and of particularities that bring them closer to or take them farther away from previous cases. This is essential to the analysis of possible business strategies, to making the most out of technical visits to other factories, or to knowing what needs to be adjusted when transferring technology from one locality to another.

The ability to make judgments of relevance or irrelevance, on the other hand, enables experienced professionals of any rank within a given organization to better prioritize their own activities, and those of their teams, according to their objectives and to unforeseen changes in context; to identify the information or datum that is important in each situation; to identify key changes or tendencies; to assess the pros and cons of the available options; and to reach the best compromise. In other words, what is relevant or irrelevant varies from one area to another and from one situation to another, and it takes experience to draw this distinction, for both the particularities of that area and the specificities of that situation must be taken into account.

Lastly, judgments of risk and opportunity apply both to decision-making of managers and executives (for instance, concerning the risks, the opportunities, and the right timing to leave or undertake a new venture or of adopting a given organizational structure rather than another) and to an operator's assessment of the risks of his ongoing or future activities. Making a judgment of risk or opportunity requires an assessment of short, medium and long-term consequences of actions that have been or can be taken, which, again, requires tacit knowledge pertaining to the area at hand.

All abilities that spring from the development of the aforementioned types of tacit knowledge in any given field of activity allow those professionals that possess them to act faster and with more accuracy. This is true both for sensory and motor abilities on the shop-floor (based on somatic tacit knowledge) and as pertaining to the ability to make “correct judgments” (based on collective tacit knowledge) in any operational or managerial activity. In the case of those abilities that require manual labor, the abilities of the body are added to those of judgment, forming thereby what is called simply “experience.”

Speed and accurate response is the result of focusing on and valuing the development and the presence of tacit knowledge in the companies. In other words, the higher the level of expertise, the faster individuals act and react to situations. A quicker risk assessment may mean the difference between a potential accident and a real one, just as assessing an opportunity may mean the difference between being the first or the second to make an innovation or to identify a new market niche. Velocity in acting appropriately has a positive impact on the effectiveness and productivity of any organization, whether relating to the use of physical abilities (somatic tacit knowledge) or to selective retrieval of information, experiences and cases in correct decision-making (collective tacit knowledge).

The current methodologies for on-the-job training are generalists and only present stages or steps to be followed. Furthermore, they do not deal with how they can be optimized so as to create a training program specifically directed towards the transfer of tacit knowledge.

Consequently, what we may call “traditional on-the-job training” may stagnate, take too long or simply not work at all. One of the reasons for this is that the more experience people acquire, the more the rules and ways of doing things competently become embedded in their practices. As a result, knowledge transfer between novices and experts presents a problem called “mismatched salience,” that situation where those learning “do not know the right questions to ask” and experts “do not realize that they must tell apprentices certain things.” (Collins, Harry (2001) Tacit knowledge, trust and the Q of sapphire. Social Studies of Science, 31(1), pp 71-85). Traditionally, the problem of “mismatched salience” is solved by the experts' overseeing of novices for months or even years on end, especially during problem-solving at work. As these problems occur, learning opportunities appear, and, in this fashion, traditional on-the-job training may work in the long-term.

The downside of traditional on-the-job training is that it is reactive rather than proactive. It is necessary to wait for problems, errors, incidents, or even accidents, real or potential, to happen, so they prompt and bring to surface the experts' tacit knowledge and give novices an opportunity for learning. That is, without a systematic way for conducting on-the-job training, novices first have to make—or potentially make—mistakes so that experts can become aware that they should have talked about a certain issue before the problem occurred, or, in case there is no time for that, so that novices can learn from their mistakes.

An additional problem is that, sometimes, the expert cannot even explain how he carries out his daily activity, because this is embedded into his practices in a manner that not even he or she can perceive. This is connected not only to the somatic abilities, but also to the types and combinations of the decisions he or she has to make—and which always require previous judgment—in work situations. So, a process is necessary that makes these points explicit to novices, something that traditional on-the-job training does not do in a focused and systematic way, as does the system here put forth.

In short, traditional on-the-job training takes a long time, is not guaranteed to work, and presents risks inherent in the ways it is normally conducted. This calls for a new method for undertaking practical training, called “On-the-job Training Technique for Transferring and Developing Tacit Knowledge”—or, in its abbreviated form, “4T System”.

As opposed to traditional on-the-job training, the method here presented has as its objective the transfer of tacit knowledge from experts to novices in the quickest way possible, with no compromise to quality of training or of work or to safety. This method presupposes that tacit knowledge issues from people's experiences in certain forms of life or technical cultures, and from the amassing of such experiences over the years. Therefore tacit knowledge can only be shared by means of a systematic process for transferring experience to novices and for the novices' development of these experiences. This demands that points of attention to be analyzed by novices and taught by experts in work situations be made explicit. These points, when analyzed and organized according to levels of complexity and interdependence on other points, form what is called a judgment tree. With the judgment tree as a central element to the process, we have also worked on the learning environments, both from the social and physical points of view. Finally, the cycle between practice and reflection is fostered, so as to allow for constant interaction and discussion of points of attention among novices, and between them and the experts, which makes on-the-job training faster.

### OVERVIEW

On the other hand, the matter addressed in the present document assumes that tacit knowledge comes from people's experiences in given forms of life or technical cultures and from the accumulation of these experiences over the years. Therefore, its presence and dissemination can only be made by managing the people who have this knowledge and the ways they interact with novices.

In order to define those people who have tacit knowledge, to estimate its quantity, and to produce an adequate personnel mix, among other things, the “levels of similarity” methodology was created. In order to define the various modes of interaction between people of higher and lower levels of similarity, within or outside of a work-related context, and so as to optimize tacit knowledge transfer, the “levels of immersion” methodology was created.

Thus, the matter here addressed solves two central problems for making tacit knowledge management operational: it qualifies professionals' previous experience and training systems and methodologies so as to maximize tacit knowledge transfer. In short, on the basis of the assumption that tacit knowledge lies within the person who possesses it—that it is localized and situational and cannot be transferred by means of computers—, ways of managing this knowledge were created, by means of group management according to levels of similarity and training management according to levels of immersion.

These as well as other aspects and advantages will become apparent to those of ordinary skill in the art by reading the following detailed description, with reference where appropriate to the accompanying drawings. Further, it should be understood that the embodiments described in this overview and elsewhere are intended to be examples only and do not necessarily limit the scope of the invention.

### BRIEF DESCRIPTION OF THE DRAWINGS

Example embodiments are described herein with reference to the following drawings.

FIG. 1 presents the Flowchart for the Levels of Similarity Methodology.

FIG. 2 presents an example: Definition of Work Collectives (defined by the dashed lines).

FIG. 3 presents an example: Planning the Mix of similarity for each Work Collective.

FIG. 4 presents an example: Follow-up of the Planned versus Real Mix of Similarity.

FIG. 5 presents the Flowchart for the Levels of Immersion Methodology.

FIG. 6 presents Levels of Immersion, Tacit Knowledge, and Types of Training.

FIG. 7 graphically presents the Calculation of Tacit Knowledge Contribution in the metallurgic Operational (a) and Maintenance (b) Teams, respectively, by Level of Similarity.

FIG. 8 graphically presents the Pre-Operational Training in metallurgic Operational (a) and Maintenance (b) Teams, respectively, by Level of Immersion.

FIG. 9 displays the general scheme of the 4T System.

FIG. 10 displays an example of the judgment tree: “Viability of the Heat.”

FIG. 11 displays an example of a different judgment tree: “Type of Intervention for Removing the Scrap”.

FIG. 12 displays an example of another judgment tree: “Process of Cutting the Scrap”.

### DETAILED DESCRIPTION

### I. Introduction

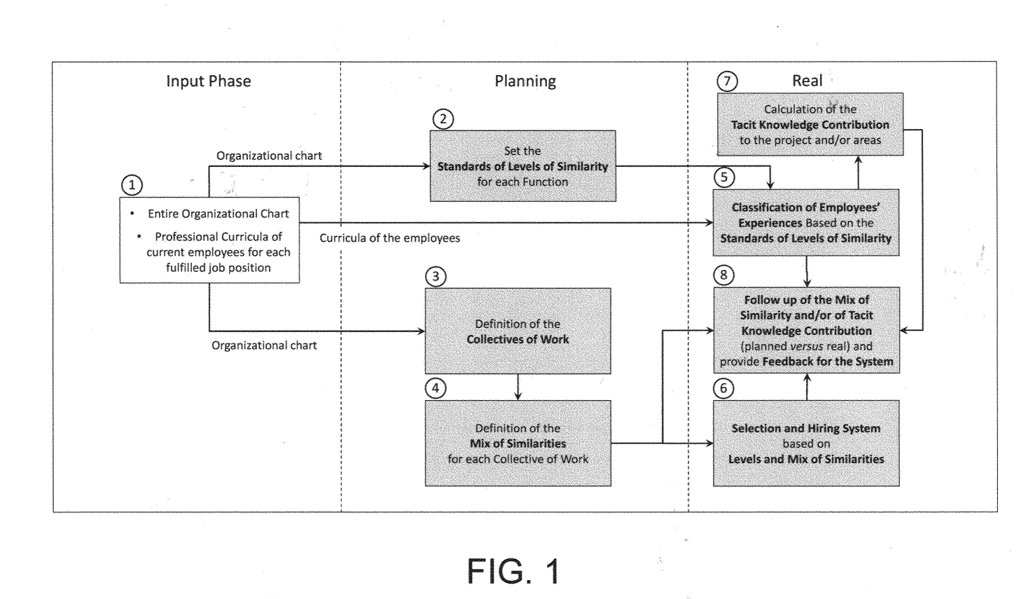

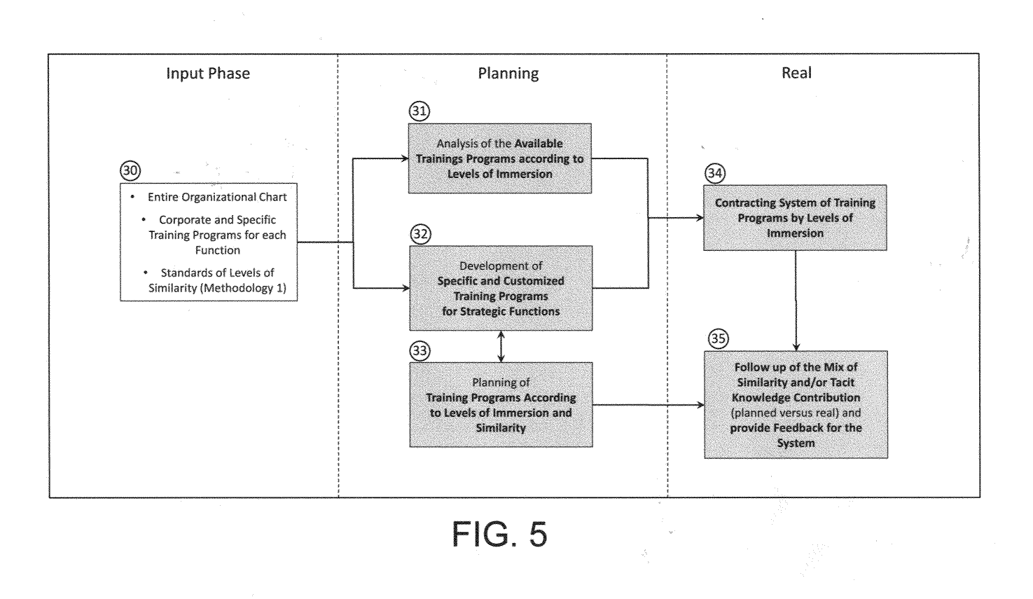

Below is presented a detailed description of each stage pertaining to the Levels of Similarity (FIG. 1) and Levels of Immersion (FIG. 5) methodologies.

After the explanation of each methodology, an item “Example” follows, along with the main results that come from the application of the methodologies involved.

### II. Methodology 1

### Levels of Similarity (see FIG. 1)

The levels of similarity methodology allows for the qualification of the previous professional experiences of seasoned professionals, whether they have already been hired or are applicants in the selection process, according to the similarity (high, medium, or low) of those experiences regarding the function to be executed. The higher the similarity, the higher the tacit knowledge that can be applied to the context under analysis.

Once the levels of similarity for each function are defined, it is necessary to plan, according to the specificities of each production process or project, the work collectives and the mix of similarity desired for each one of those collectives. This is what will allow not only for the company to attain, in the future, its productivity, quality, and safety goals, but also the optimization of tacit knowledge transfer from professionals with high similarity to those with medium and low similarities.

The follow-up of the planned versus real mix also allows for the identification of the gaps that exist in the teams, in the selection/hiring systems, and in the composition of the work collectives, opening up space for the taking of preventive and corrective actions, as will be illustrated ahead. Lastly, the classification of experiences existing in the work collective allows for the quantification of time of qualified experience for an analysis of the current situation in different areas and for a future estimation of what the appropriate “tacit knowledge contribution” would be for each project or production process (see item “Example”).

For the application of Methodology 1, Levels of Similarity, there are at least two inputs ^{\textcircled{1}} (the number referring to the stages or parts indicated in the figures):
A complete organizational chart for the project or section under analysis, with the number and name of the distinct hierarchical levels, the number of vacant work positions in each level and the position and function for each position. The definition of the function relates to the person's job title (for instance, furnace operator), while the position pertains to the pay level (for instance, Furnace Operator 3, instead of Operator 2);
A professional curriculum of candidates and/or of those who already hold the functions being analyzed, where each professional experience is discriminated in terms of functions executed, even inside the same company, with entry and exit date, and detailed description of the activities effectively performed for each one of the functions executed.

Methodology 1 of Tacit Knowledge Management by Level of Similarity is comprised of at least 4 stages:
identifying, in terms of tacit knowledge, the specificities of each function within a project (i.e. the standards of levels of similarity)^{\textcircled{2}},
identifying the work collectives existing in a project ^{\textcircled{3}};
planning the work collectives with an adequate mix of professionals so as to guarantee the presence of tacit knowledge in each group and optimize its transfer ^{\textcircled{4}};
identifying gaps in the tacit knowledge existing in each group, thereby making possible the taking of corrective actions ^{\textcircled{5}}.

This methodology may comprise at least two additional stages:
developing a system for hiring professionals based on the analysis of candidates' tacit knowledge ^{\textcircled{6}};
calculating the tacit knowledge contribution necessary for the project and/or other specific areas ^{\textcircled{7}}.

These stages can be supervised, so that the system receives information feedback, enabling managers to reorganize the groups and the selection and hiring systems, as well as the attraction and retention of people with high similarity levels ^{\textcircled{8}}.

Definition of Standards of Levels of Similarity for each Function ^{\textcircled{2}}

The definition of standards of levels of similarity for each function ^{\textcircled{2}} consists of the description, in writing, of the professional experiences that more closely resemble the function under analysis, as well as the average span of time a professional must have worked in that situation so as to have had the opportunity to develop the function's specific tacit knowledge. Table 2 shows the similarity level standard for three functions within distinct areas of the industrial plant. The explanation begins from the top of the table (first line of Table 2).

TABLE 2
Examples: Standards of Levels of Similarity for Three Functions

| | DEFINITIONS | | | | | |
|---|---|---|---|---|---|---|
| FUNCTIONS | LOW SIMILARITY | Time | MEDIUM SIMILARITY | Time | HIGH SIMILARITY | Time |
| HYDRAULIC | EXPERIENCE AS AN | 3 years | EXPERIENCE AS AN | 3 years | EXPERIENCE AS AN | 5 years |
| EXCAVATOR | OPERATOR OF A | | OPERATOR OF A | | OPERATOR OF A | |
| OPERATOR | SMALL HYDRAULIC | | HYDRAULIC | | HYDRAULIC | |
| | EXCAVATOR | | EXCAVATOR IN | | EXCAVATOR IN | |
| | | | OPEN PIT MINES | | OPEN PIT LATERITE | |
| | | | | | NICKEL MINES | |
| MOTOR | EXPERIENCE AS A | 3 years | EXPERIENCE AS A | 3 years | EXPERIENCE AS A | 3 years |
| GRADER | WHEEL LOADER | | MOTOR GRADER | | MOTOR GRADER | |
| OPERATOR | OPERATOR | | OPERATOR IN | | OPERATOR IN | |
| | | | ROADS | | OUTDOOR MINES | |
| CONTROL | EXPERIENCE AS A | 3 years | EXPERIENCE AS A | 5 years | EXPERIENCE AS A | 3 years |
| ROOM | CONTROL ROOM | | CONTROL ROOM | | CONTROL ROOM | |
| OPERATOR | OPERATOR IN ANY | | OPERATOR OF | | OPERATOR OF | |
| CALCINING | INDUSTRY | | ROTARY FURNACES | | ROTARY FURNACES | |
| | | | OR DRYERS (eg. | | IN THE NICKEL | |
| | | | Cement, Clay, Lime) | | INDUSTRY | |

Most people with experience in the trades would say that a hydraulic excavator operator is a “hydraulic excavator operator” no matter where he works. Those with experience in laterite nickel mining, however—which is the case under analysis here—do not agree. From their point of view, a high-similarity worker for this function must have worked within open pit laterite nickel mine for at least five years. Laterite nickel mines are classified as “selective mines:” those in which it is possible to visually identify the ore veins within the block to be mined. However, only people with “trained eyes” are able to make the correct distinction (and that requires the development of tacit knowledge pertaining to that visual activity). Furthermore, specialists typically believe that it takes approximately five years for the average person to operate a hydraulic excavator and to visually distinguish the ore vein from the rest of the block, which allows for improved productive efficiency on the part of the operator.

An outsider may consider that, in addition to having similarity in operating a motor grader (second line, Table 2) at the same mine in which the hydraulic excavator operator works, it would also be necessary for the mine to be an open pit laterite nickel mine, but that is not the case. The experience of operating a motor grader at any open pit mine is sufficient for someone to be classified as of high similarity. This is because this function does not depend on the type of ore in the mine where they will be working, but only on the type of mine (open pit or underground), given the differences that exist in operating working vehicles (many of which are enormous off-road vehicles) safely in different types of mines.

In the case of the control room operator of the calcining line (third line, Table 2), a couple of experts argued that operating a rotary kiln in a cement factory is actually much harder than in a nickel plant. Hence, the average person would need Jive years of experience to be considered a professional operator for the former while three years would suffice for the latter.

The aforementioned examples show how the standards of levels of similarity allow for greater detailing of the relevance points in professional experiences, so as to make distinctions among experiences that were previously held as equal—as are the cases for hydraulic excavator operators, motor grader operators, etc. Furthermore, it is possible to ascertain that, contrary to what many would think, more years of experience is not a guarantee for higher levels of similarity, just as a smaller number of years of experience does not mean lower levels of similarity—as the cases of kiln operators in the cement versus laterite nickel plants exemplify.

Definition of Work Collectives ^{\textcircled{3}}

Tacit knowledge is transferred through daily contact in work situations, where, for instance, the differences that need to be perceived (e.g. the ore vein versus the rest of the block) are shown and learned by means of practical experience while shadowing a high-similarity professional. Thus, it is necessary to identify the groups of professionals who work together, both in physical terms and in terms of the activities performed—what are called “work collectives.”

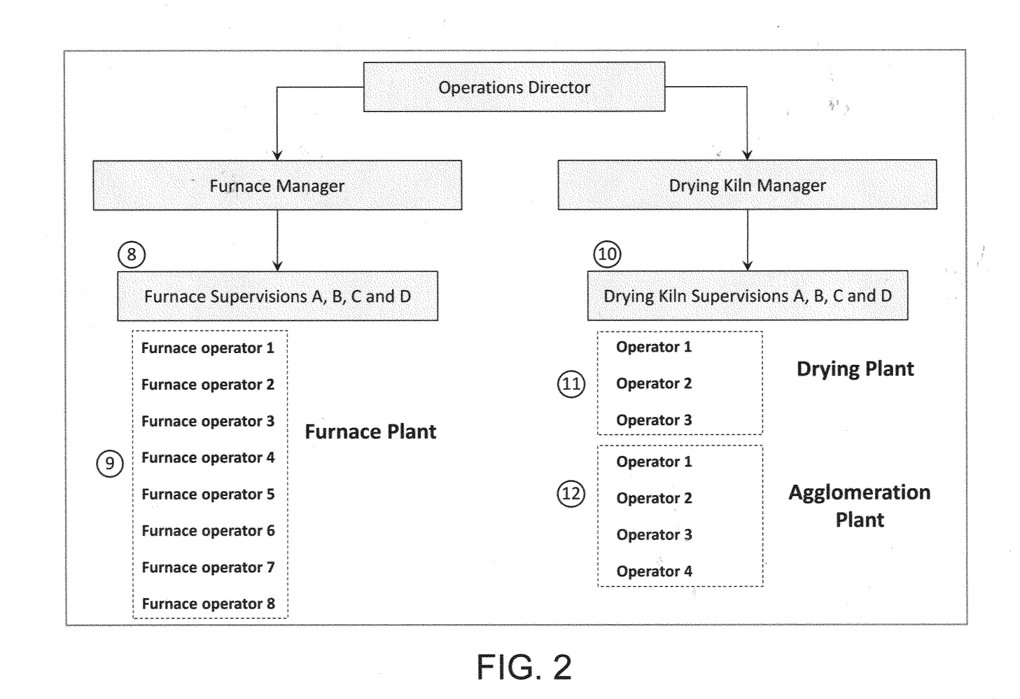

An example of work collectives in the case under analysis (see FIG. 2) is the group of eight people ^{\textcircled{9} that forms each one of the four Supervisions of Furnace Operators teams} ^{\textcircled{8}}. They always work during the same shift, and their function is to open and close the electric furnace—a very dangerous operation, given that the liquid metal leaves the furnace at over 1000° C. [1,832° F.]. In this case, each supervision ^{\textcircled{8}} consists of one work collective, but there are cases in which there is more than one work collective for each supervision. For instance, the Drying Kiln Supervision ^{\textcircled{10}} is comprised of a group that works in the drying plant ^{\textcircled{11}} and another that works in the agglomeration plant ^{\textcircled{12}}. These are two different activities that are performed in two different places. Therefore, the group's components do not share daily activities regarding the task to be done and cannot be considered as belonging to the same work collective, but only to two distinct work collectives.

Definition of the Mix of Similarity for each Work Collective ^{\textcircled{4}}

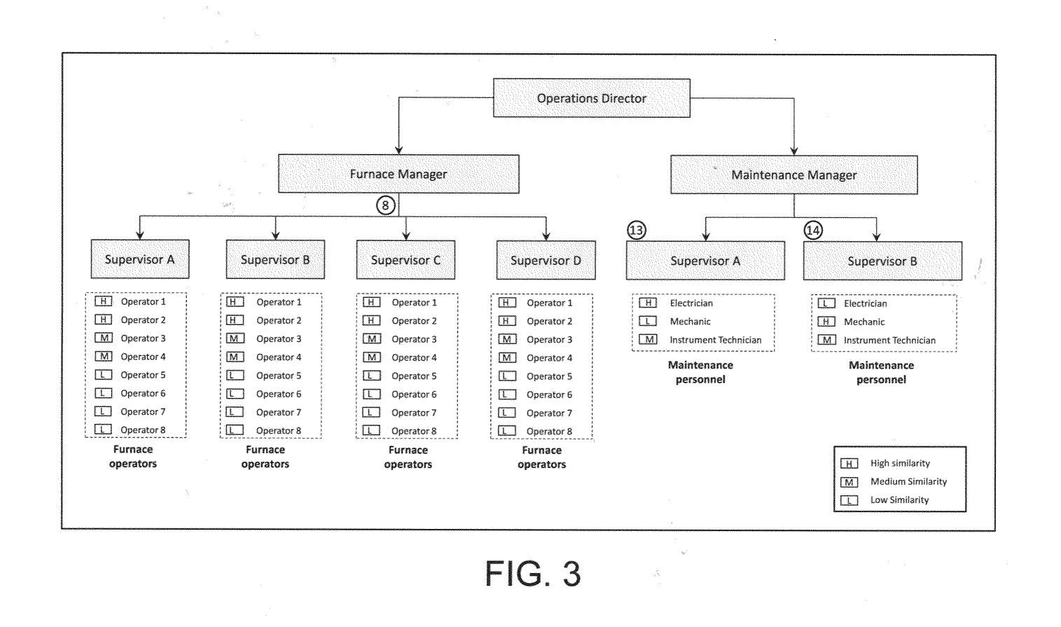

It would be ideal to create a team that only had people with high similarity, for the money spent on training would be less, the results would come faster, and the safety rate would be higher. However, this is not always possible. Thus, it is important to define what would be the most adequate mix of similarity for each one of the existing work collectives. For example, in planning the mix of similarity for the four supervisions of furnace operators ^{\textcircled{8}} (see FIG. 3), the conclusion was reached that, since there were four shifts and four different work collectives, at least four people with high similarity (one for each turn) would be necessary, but the ideal would be two people with high similarity, due to the existence of days off, holidays, or even unforeseen events, such as illnesses or accidents.

In a different case, Maintenance Supervisor A ^{\textcircled{13}} (see FIG. 3), an expert in mechanics, decided that he would hire a high similarity electrician (in order to supplement his deficiency) and a low similarity mechanic (whom he could easily train). His colleague, Maintenance Supervisor B ^{\textcircled{14}}, in his turn, did exactly the opposite, as he was an expert in electrical maintenance.

In short, the correct definition of the mix of similarity can be thought of in terms of some basic principles, such as the size of the groups, the complexity of a function, whether the groups work in shifts or during business hours, etc. Nevertheless, as new professionals are hired, the mix can be adapted according to every new situation, so the best possible team in terms of similarity may be put together and thus guarantee the presence of the relevant tacit knowledge.

Classification of Professional Experiences based on Standards of Levels of Similarity ^{\textcircled{5}}

This stage ^{\textcircled{5} is comprised of a detailed analysis of professional curricula based on the levels of similarity defined for each function. Thus, if a person worked over twenty years for three different companies, performing in total six different functions, then it is necessary to analyze how precisely each one of those functions effectively performed fits into each of the three levels of similarity defined for the function, as well as how long that person stayed in each one of the six functions. After this analysis, the different time periods of high, medium or low similarity experience are added up.}

For instance, after analyzing the curriculum of a person with over ten years of experience, the conclusion was reached that two of those ten years was of high similarity, four were of medium similarity, and the rest were of low or no similarity at all. Since the standard had established that one would need five years of experience in that function in order to have high similarity, this person was not considered as having high similarity, but instead only medium, for which the time of experience required was three years. There was another case, concerning the function of furnace operator in a laterite nickel plant, in which people with over twenty years of experience with calcination at cement factories were considered as having medium similarity, because of the learning they would have to undertake in order to understand the more modern and automated equipment used in the plant, the operational parameters, and the operation of the equipment in the new nickel plant.

It is important to stress that the classification of professional experience by levels of similarity applies both to the analysis of those people who already hold the position in question and of selection processes and staff hiring (see item 6 below).

Selection and Hiring System based on Levels and Mix of Similarity ^{\textcircled{6}}

Based on the levels of similarity standards for each function and on the plan of desired mixes of similarity for each work collective, there is the option to establish a selection and hiring system with a view to attaining the defined goal. Consequently, in the case where this methodology was utilized, it had a positive impact both on the rearrangement of work collectives (where positions were already taken) and on the system of selection and hiring (when there were vacant positions), since many of the managers were surprised by the analysis made concerning their teams (see item “Example” below).

Calculation of the Tacit Knowledge Contribution to a Project/Area ^{\textcircled{7}}

Just as the financial contribution to a project is planned and calculated, it is also possible to plan and calculate the tacit knowledge contribution to a project or to specific areas ^{\textcircled{7}}, such as a department or supervision.

The calculation is done using the plant's number of functions/future employees, the desired mix of similarity, and the number of years of experience for each desired similarity level. This operation allows for the calculation of the total number of years of high, medium, and low similarity desirable for the project or for specific areas, as well as for the follow-up of such numbers, as the classification of curricula of people hired ^{\textcircled{5}} is done according to the levels of similarity.

Follow-Up of Planned Versus Real Mix of Similarity and/or of Tacit Knowledge Contribution and System Feedback ^{\textcircled{8}}

As applicants are hired (or when part of the hiring has already taken place, as it had in the case analyzed) there is the option of following up on what was planned regarding the real picture that is gradually formed.

This stage consists of comparing the planned mix of similarity versus the real one, so that the appropriate measures can be taken, should they be necessary. For instance, if the hiring of someone with high similarity for a given function was not successful, it is possible to raise wages or to improve the package of benefits in order to attract better applicants, or it is also possible to hire a consultant or retired professionals to work in another newly hired person's stead until that person (who has low or medium similarity) has been properly trained. In the case to which the levels of similarity were applied, there were many situations in which real problems were identified due to the methodology, and solutions similar to those were effectively taken (see item “Example” below).

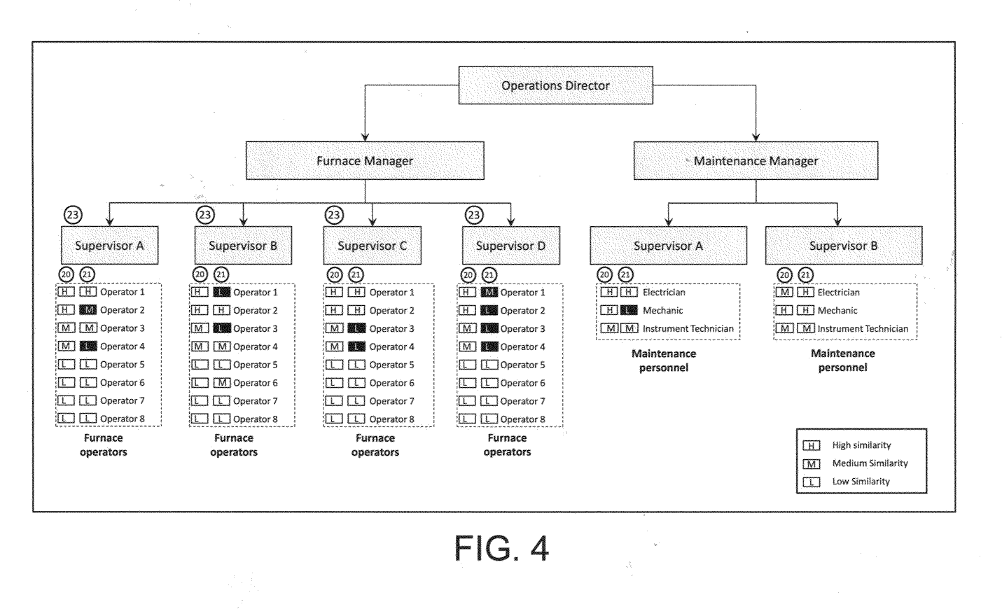

FIG. 4 shows an example of comparison between the planned versus the real mix concerning furnace operators and maintenance supervisors A and B. The two squares in front of the functions illustrate, respectively, the planned ^{\textcircled{20}} and the real ^{\textcircled{21}}. When the real ^{\textcircled{21}} negatively differs from the planned (for example, a person with high similarity was expected to be hired, but the company ended up hiring one with medium or low similarity), the second square ^{\textcircled{21} becomes black with white letters, so as to provide a warning about the problem. Thus, the area manager may try to compensate for this loss by hiring a professional with a higher level of similarity for the positions that are still vacant.}

It is also possible to follow up on the planned versus the real tacit knowledge contribution for the project as a whole and/or for specific areas of the project. This allows for the planning of future projects in terms of what the tacit knowledge contribution required would be, and, above all, for the identification of gaps in the tacit knowledge contribution concerning the areas under analysis, thereby making it possible to take corrective actions (see item “Example”).

### III. Methodology 2

### Levels of Immersion (see FIG. 5)

The Level of Immersion methodology allows for the qualification of types of training according to a given level of immersion. There are four levels of immersion. Self-study is studying a certain technical area exclusively by oneself. Though they can learn many facts about the area, self-taught people, since they do not interact with experts, cannot judge the relevance of what they read and whether, for instance, they are reading something up-to-date or dated. In short, the self-taught person cannot make any kind of technical judgment.

Linguistic socialization is the opportunity of interacting, linguistically and far from the work environment, with experts in the field under analysis. Those who learn about a field of study or practice solely through linguistic socialization may be capable of assessing the technical relevance of all that is amenable to verbalization, but they cannot perform tasks that depend on interacting with the work environment (such as analyzing the color of the smoke that comes out of a factory stack, the sound of an engine to see if it has problems, etc.).

Physical contiguity consists in the possibility of interacting with experts in the workplace, but without actually working hands-on. And, lastly, physical immersion refers to actual physical practice. Those who have the opportunity of experiencing these kinds of immersion develop—to a lower or higher degree—somatic tacit knowledge, which is connected to bodily abilities, such as hearing, smell, sight, touch, etc.

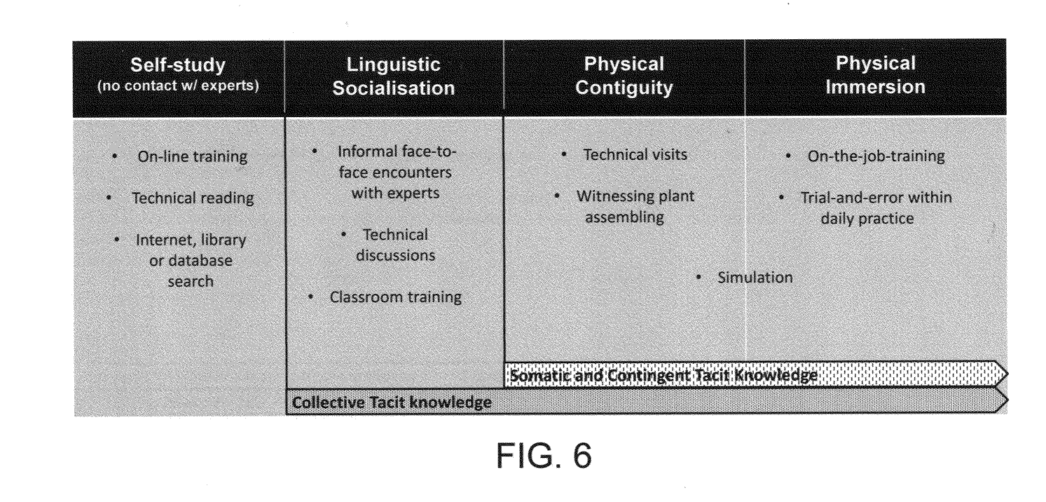

The development of different types of tacit knowledge is associated with going through certain types of immersion, so that, for instance, somatic tacit knowledge (pertaining to the human body) and part of the contingent tacit knowledge (pertaining to work practices) can only be acquired through physical contiguity (but especially through physical immersion), while part of the collective tacit knowledge (pertaining to the immersion in a given form of life or technical culture) can only be acquired through linguistic socialization. FIG. 6 shows some examples of training activities and how they fit into the proposed levels of immersion, as well as the relation between such levels and the development of different types of tacit knowledge.

Generally, it is possible to assert that the higher the level of immersion within the continuum of self-teaching, linguistic socialization, physical contiguity, and physical immersion, the higher the likelihood of transferring the different types of tacit knowledge. Consequently, there is room for a systematic plan concerning training systems and methods with a view toward developing the required types of tacit knowledge. It also becomes possible to identify gaps in the training systems with regard to the requirements of each specific function (see item “Example”).

The final result is the optimization of tacit knowledge transfer and the possibility of developing, based on this methodology, a complete planning, execution and contracting system for training, reducing costs and—at the same time—optimizing training with a view to developing tacit knowledge.

In applying the Levels of Immersion methodology, there are at least three inputs ^{\textcircled{30}}:
A complete organizational chart for the project or section under analysis, with the number and name of the distinct hierarchical levels, the number of vacant positions in each level, and the position and function for each spot. The definition of the function relates to the employee's job description (for instance, Furnace Operator), while the position pertains to the pay grade (for instance, Furnace Operator 3, instead of Furnace Operator 2);
Definition of corporate and specific training programs (internal and external) per function; and
Standards of Similarity for each function.

The Methodology for Tacit Knowledge Management by Levels of Immersion is comprised of at least three stages (see FIG. 5):
identifying gaps in training systems regarding their contribution towards tacit knowledge transfer, making it possible for corrective action to be taken ^{\textcircled{31}};
determining and developing types of training that are more adequate for certain strategic functions, based on their specificities ^{\textcircled{32}}; and
planning and assembling optimized training systems directed specifically towards the development of the different levels of new employees with respect to tacit knowledge ^{\textcircled{33}. This methodology may contain at least one additional stage:}
developing a system for contracting training programs based on their contribution towards tacit knowledge transfer ^{\textcircled{34}}.

These stages can be monitored, so that the system receives feedback that allows managers to improve the training and contracting process, focusing on the development of the team's tacit knowledge ^{\textcircled{35}}.

Analysis of Available Training Programs According to Levels of Immersion ^{\textcircled{31}}

In this stage, the corporate and specific training programs, internal or external to the company, related to a given function, have their methodologies analyzed according to the levels of immersion, as exemplified in FIG. 6.

This creates the possibility of identifying problems in the training programs related to certain functions—for instance, excess or lack of methodologies linked to some degree of immersion—, based on the peculiarities of the function in question. For this reason, the analysis of each function's specificities, undertaken at the time of defining the standards of levels of similarity, avails the definition of the type(s) of immersion that are more appropriate to each function's different nature, and consequently its comparison to the available training programs.

Development of Specific and Customized Training Programs for Strategic Functions ^{\textcircled{32}}

On the basis of stage ^{\textcircled{31}}, that is, of the standards of similarity for each function and of the definition of which functions would be strategic for the process—in virtue, for instance, of their peril to or their impact on the production process—, this methodology makes room for the development of customized training strategies, since they are based on the types of immersion appropriate for developing specific types of tacit knowledge.

Planning of Training Programs According to Levels of Immersion and Similarity ^{\textcircled{33}}

The planning consists of the analysis of the methodologies employed according to the levels of immersion in which they are inserted, so as to produce “balanced” training programs for each one of the functions pertaining to the industrial plant. For this purpose, it is necessary to have a basic understanding concerning the types of tacit knowledge necessary to the functions under analysis. This is partly provided by the discussion produced through the execution of the standards of levels of similarity (Methodology 1). This “balance” in the designed training program may vary from function to function, once there are functions that have greater cognitive or manual load, or vice versa.

In addition to planning according to levels of immersion, there is the development according to levels of similarity. That is, if two people—one with a low level of similarity and another with a high level—are hired to perform the same function, they should not receive the same type of training, since the percentage of each type of immersion in composing the training program should be defined according to people's previous experience—hence the decision to place this stage in Methodology 2. For example, while it is important for the inexperienced furnace operators that the greater part of their training is on the level of physical immersion—by actually tapping metal and plugging the taphole from where the metal comes out of the furnace—the most important thing for the experienced operators is to have a greater load of linguistic socialization, where the differences between the furnace they operated previously and the one they will operate in the new plant will be addressed.

In short, the planning of training programs according to levels of immersion and similarity consists in a refining of training systems as they were previously understood, that is, when we did not know how to deal with tacit knowledge in organizations.

System for Contracting Training Programs According to Levels of Immersion ^{\textcircled{34}}

The understanding of the methodology of levels of immersion allows us to go further and apply the company's internal analysis of its own training system to the external system for contracting training programs and to the external training programs that have already been hired (see item “Example”).

Follow-Up on Planned Versus Real Training Programs According to Levels of Immersion and Similarity and System Feedback ^{\textcircled{35}}

In this stage, one conducts a follow-up on the real as contrasted with the planned, identifying not only alterations in the quantity of trainees for each level, which may have changed due to hiring adjustments, but also the effectiveness of training programs. This will produce alterations in what pertains, respectively, to the organization of the teams and the participation of each type of immersion in correcting occasional digression from the real application of training programs and their results.

The training analysis according to levels of immersion also allows for the identification of training gaps directed towards tacit development in specific areas, which is essential for managers to take corrective action (see item “Example”).

In short, one can observe that the methodologies addressed here provide practical means for making Tacit Knowledge Management operational in organizations.

### EXAMPLE

The methodologies of tacit knowledge management according to levels of similarity and immersion have already been applied to a $2.8 billion metallurgic plant located in Brazil. Below is a detailed description of the results of applying these methodologies on that company. Following the description of the results can be found, in parentheses, the corresponding stages of those methodologies that generated such a result.

It can also be seen that the stages referring to the levels of similarity and levels of immersion methodologies (including the “additional” and the “real versus planned follow-up” stages) are illustrated below by the practices carried out in the metallurgic plant located in Brazil.

### Levels of Similarity—Methodology 1 (FIG. 1)

Identifying, in Terms of Tacit Knowledge, the Specifics of Each Function within a Project (^{\textcircled{2}}).

As previously described, in order to classify people's professional experiences, it is necessary to create a standard of levels of similarity for each one of the functions of the industrial plant. The elaboration of such a standard, therefore, allows for an explanation of the most relevant points of the function being analyzed and its differences in relation to experiences previously held as similar. The qualifiers used in the standards of levels of similarity are then a distinguishing feature in composing work collectives with the mix required for optimizing tacit knowledge transfer.

A precise definition for each function, where that experience which makes possible the acquisition of the tacit knowledge specific to that function is made explicit (see the case of the “hydraulic excavator operator”), leads to the precise identification of that professional who should produce more efficiently and safely, as well as of that professional who is the most adequate to train people with lower levels of similarity.

Identifying Gaps in the Tacit Knowledge Existing in Each Group, Thereby Making Corrective Action Possible (^{\textcircled{3}}, ^{\textcircled{4}}, ^{\textcircled{5}}).

After analyzing professional experiences according to levels of similarity, it was possible to identify the areas within the project under study where high similarity professionals were lacking, that is, where the mix was not adequate (see FIG. 4). In other words, though there were people with a good deal of prior experience, that experience had no relation to the tacit knowledge which is specific to the function in question. This lucidity regarding the people who composed the groups lead managers to alter the structure of their management, opening up new positions for the hiring of high similarity people who could provide support in technical aspects where there were no adequate workers. There were also cases of redefinition of positions that had already been taken, so as to change wages and benefits for the better, in order to retain those people who had high similarity. Lastly, the managers perceived, in a clear manner, the necessity of attracting and keeping high similarity people, including for the lowest positions within the project's operational hierarchy. For this purpose, a negotiation was undertaken with the company's Human Resources Department, so that these people—mechanics, electricians, etc.—were given more incentives to stay; for example, the right to company housing. This negotiation was successful, and many workers obtained benefits partly due to this global view on the composition of the group that applying the concept of levels of similarity allowed project managers to have.

Identifying Gaps in Tacit Knowledge Through an Analysis of the Tacit Knowledge Contribution for Each Area, Thus Enabling Corrective Action (^{\textcircled{7}}).

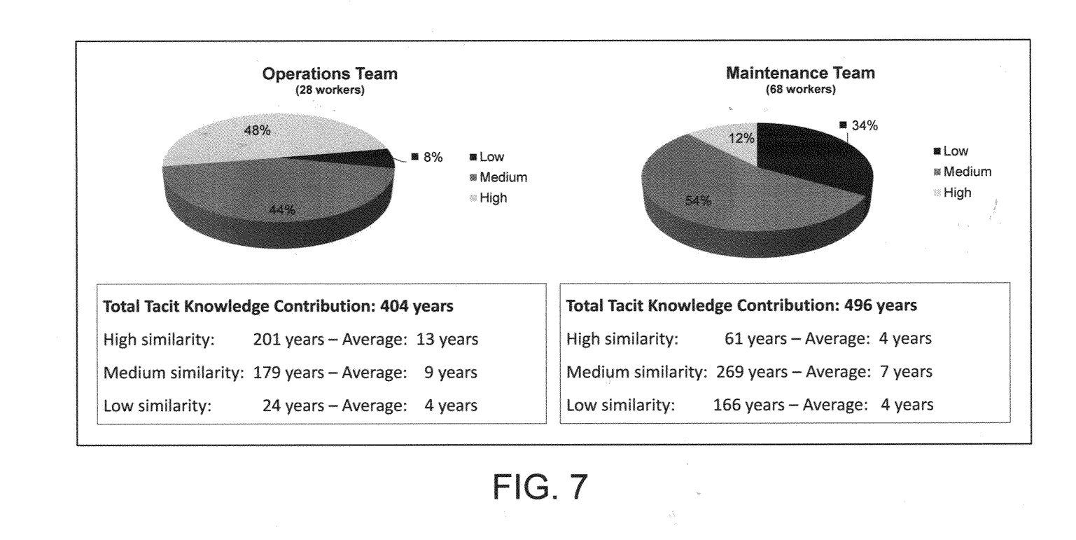

Aside from analyzing the existing mix of similarity, an analysis of the tacit knowledge contribution of specific areas was also done. For instance, it was calculated that the Metallurgic Operations had a team whose previous professional experience totaled 404 years, 201 of high similarity (48%), 179 of medium similarity (44%), and 24 years (8%) of low similarity, where the high similarity average rate per person, among these workers was 13 years, while the medium similarity average was 9 years and the low similarity average was 4 years (see FIG. 7a). On the other hand, the Metallurgic Maintenance team had 496 years worth of experience, where only 61 were of high similarity (12%) and 269 years were of medium similarity (54%), with far lower averages: 4 and 7 years, respectively, for high similarity and medium similarity professionals (see FIG. 7b). In other words, the Operations Team was much more prepared for operating the industrial plant than the Maintenance Team was for maintaining it.

Planning Work Collectives with an Adequate Mix of Professionals so as to Guarantee the Presence of Tacit Knowledge in Each Group and Optimize its Transfer (^{\textcircled{4}}).

When the analysis concerning the mix of similarity of the professionals already on the payroll was completed, there were still about 900 professionals to be hired for the project as a whole. This way, managers and supervisors were able to plan their next appointments based on this methodology. Namely, they started thinking in terms of the mix of similarity they would like to have on their teams. Several ways of making a mix were then contemplated and prepared, such as having at least one high similarity person per shift, so as to obtain not only the precise execution of activities, but also the transfer of that knowledge to the rest of the group. There were cases in which maintenance supervisors with different similarities—one with higher similarity in mechanic maintenance and the other in electric maintenance—agreed amongst themselves that the selection of mechanics, in both supervisions, would be performed by the employee who had higher similarity in mechanics, while the selection of electricians and instrument technicians would be made by the worker who had higher similarity in electronics. Finally, as mentioned before, several modifications were also made to the benefits and employment packages pertaining to some positions that had not yet been filled, so as to attract high similarity people to the project.

Developing a System for Hiring Professionals Based on the Analysis of Candidates'Tacit Knowledge (^{\textcircled{6}}).

After the elaboration of the standards of levels of similarity for each function, the descriptions employed for each level were included in the position requests sent to the company's human resources department, for the selection of the new employees. This indicates the possibility of a significant change in companies' hiring systems, taking into account the analysis of applicants' tacit knowledge. That is, the selection and hiring system is refined given that the basic experiences, through which the candidates must have gone—so as to have acquired that specific tacit knowledge for their intended function in the project —, are made explicit.

Follow-Up of the Mix of Similarity and/or of the Tacit Knowledge Contribution for the Taking of Corrective Action (^{\textcircled{7}}, ^{\textcircled{8}}).

After taking the corrective actions necessary for improvement where gaps were identified in the mix of similarity and/or in tacit knowledge contribution, a follow-up was conducted on the results of those actions by means of analyses such as the ones illustrated in FIG. 4 and FIGS. 7a and 7b.

### Levels of Immersion—Methodology 2 (FIG. 5)

Identifying Gaps in Training Systems with Regard to their Contribution Towards Tacit Knowledge Transfer and subsequent Corrective Action (^{\textcircled{31}}).

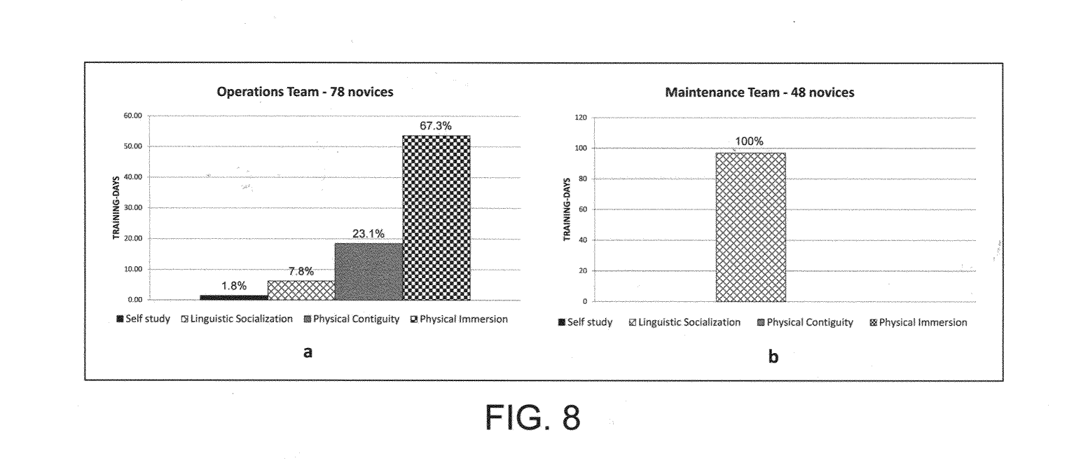

When the pre-operational training given to novices was analyzed, 91.4% of the 6,215 training days for novices in the area of Metallurgic Operation up to January 2009 fell into those two levels of immersion categories—“physical contiguity” and “physical immersion”—that contribute the most towards the acquisition of tacit knowledge (see FIG. 8a). In contrast, it was observed that in the area of Metallurgic Maintenance there was no type of training whatsoever in these two levels; 100% of the 4,651 training days for novices in this area fell into the category of “linguistic socialization”—the level right below “physical contiguity” (see FIG. 8b). Thus, it became clear to the company that it was necessary to reevaluate their whole training system for the area of Maintenance. This began just after this analysis was performed and after a high-similarity professional was hired to manage this area.

Planning Optimized Training Systems and Methodologies Directed Specifically Towards the Development of the Different Levels of Trainees as Regards Tacit Knowledge (^{\textcircled{32}}, ^{\textcircled{33}}).

Based on the concepts described, a training system was created, focusing on the transfer of tacit knowledge. That is, the concept of levels of immersion was systematized and institutionalized as a strategy for thinking and designing better training programs to be offered in some areas of the plant. Those training programs that did not present the workload expected in the highest levels of immersion were understood as programs that did not contribute to the acquisition of tacit knowledge on the part of the trainees, and therefore would benefit from readjustment.

Identifying the Types of Training that are More Adequate for Certain Functions Given their Specificities (^{\textcircled{33}}).

Each function within the industrial plant has its own specificities. Although they all possess cognitive content, some functions demand more motor skills than others. This entails the necessity of devising different strategies for training novices according to the functions they are to perform. For instance, a furnace/metal operator must be capable of distinguishing metal from slag by observing different shades of yellow and orange. In order to do so, it is necessary (at minimum) to take part in a training in “physical contiguity,” since the ability to draw such a distinction lies in the acquisition of somatic-type tacit knowledge—which can only be acquired at the two highest levels of immersion. This is used for planning and putting together specific training programs, as is the case with the furnace/metal operator.

Developing a System for Contracting Training Programs Based on their Contribution Towards Tacit Knowledge Transfer (^{\textcircled{34}}).

The concept of “levels of immersion” made an impact on the contracting of training programs in two ways: First, training programs that were about to be implemented were either revised or cancelled, since their methodologies were not directed towards developing tacit knowledge.

In other cases, when some proposal requests and price quotes were issued, the scope sought after included greater detail concerning the types of training that should be offered by the company and about the type of professional that was desired (based on the idea of levels of similarity). For instance, in a given descriptive memo, it was requested that the professional was experienced in operation, maintenance, and technical assistance, because, for the case in question, such a professional would have to take six-people teams on field trips in order to show them the main problems that could affect the equipment and, above all, the preventive security measures to be taken. For this reason, a great part of the training request was in physical contiguity and physical immersion activities (75%), and the remainder in linguistic socialization (25%).

Follow-Up of the Training Programs According to Levels of Immersion for the Taking of Corrective Action (^{\textcircled{35}})

Lastly, a quantitative and qualitative follow-up system concerning the training programs offered, according to levels of immersion and their connection to the development of the types of tacit knowledge specific to the function, was established. The goals were to follow-up on and update the analyses carried out (such as illustrated in FIGS. 8a and 8b), so as to identify the results of the changes made in training systems/methodologies concerning each one of the operational areas in the plant—but with an initial emphasis on the Metallurgic Operation and Maintenance teams, which were the newest areas in the company.

### III. OJT Training Technique for Transferring Tacit Knowledge

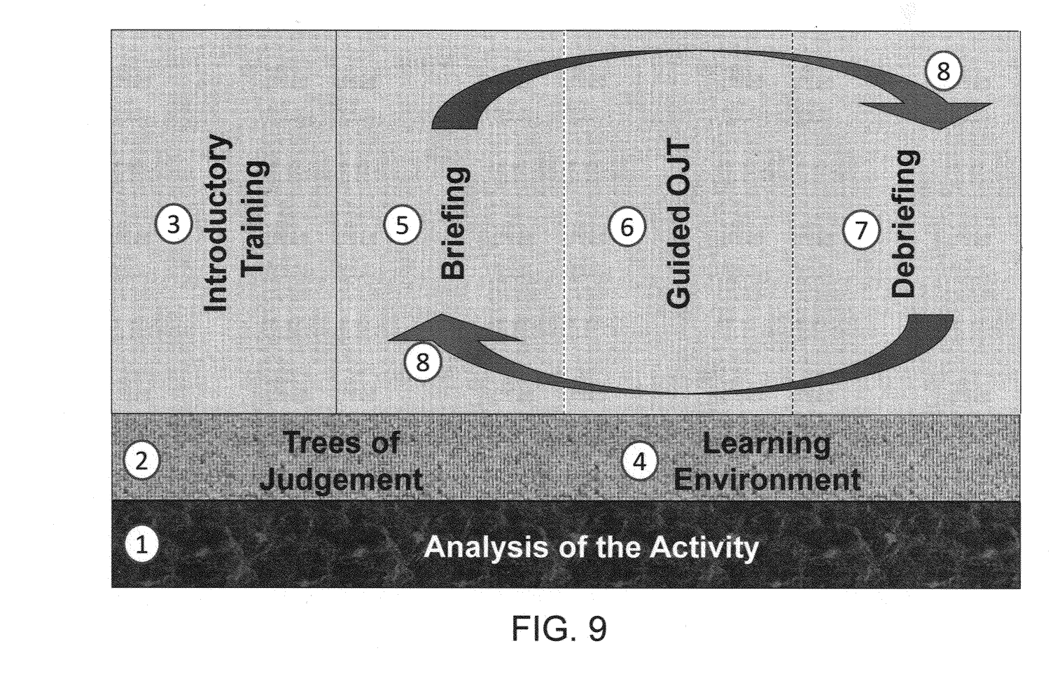

Below is a detailed description of each stage in the On-the-job Training Technique for Transferring Tacit Knowledge (FIG. 9). References to \textcircled{1}, \textcircled{2}, \textcircled{3}, \textcircled{4}, \textcircled{5}, \textcircled{6}, \textcircled{7}, and \textcircled{8} in section III of this description pertain to the same numbered references in FIG. 9.

After the explanation of the process, there follows the item “Example,” where some of the main results that spring from the application of the technique described here are presented.

The On-the-job Training Technique for Transferring Tacit Knowledge can be comprised of any of the following stages (see FIG. 9):

a) Analysis of the activity \textcircled{1}, where the real activity is defined and its intrinsic characteristics are uncovered;

b) Making of the judgment tree \textcircled{2}, where the levels of complexity and interdependence between judgments are identified and ordered hierarchically in the form of a tree;

c) Introductory training \textcircled{3}, where experts and novices are rendered capable to utilize the technique;

d) Creation of a learning environment \textcircled{4};

e) Briefing \textcircled{5}, where experts define the target judgments to be developed by providing information about the meaningful points of attention to be focused on the next work situation;

e) Guided On-the-Job Training (G-OJT) \textcircled{6}, where novices perform target tasks with the experts' oversight;

f) Debriefing \textcircled{7}, where novices are evaluated by experts on their performance in the Guided OJT \textcircled{6} and other meaningful events; and,

g) Repetition and feedback of stages 5, 6, and 7 \textcircled{8}.

Analysis of the Activity \textcircled{1}

The On-the-job Training Technique for Transferring Tacit Knowledge is characterized by the stage of analysis of the activity \textcircled{1}, which can include any of the following steps:

a) gathering of related documents;

b) oversight of practices;

c) guided overseeing of activities;

d) self-confrontation;

e) instruction of the double;

f) confrontation between prescribed and real activity;

g) investigation of actions in situated perspective; and,

h) listing of required judgments.

To begin this stage, all documents related to the activity and the team, such as standard operating procedures (SOPs), functional organization charts, transcripts, foci and content of formal training programs in which the professionals have taken part, as well as technical curricula must be gathered.

Concomitantly, the oversight of practices must be initiated, and, if necessary, the oversight of other daily events, such as meetings, training programs, professional interactions, and even more informal situations. Non-structured interviews also contribute to a better understanding of the aspects of the activity which can be verbalized, as well as information concerning the practical curricula of the professionals (e.g. previous experiences, time of experience with the activity, etc.), with the possible recording and transcription of interviews, so that analysis and search engines may be used and render subsequent stages easier.

These initiatives have as their objective the search for basic elements for the utilization of the following analysis tools: “guided overseeing of activities,” “self-comparison” and “instruction of the double.”

During the “guided overseeing of activities,” the analyst must be instructed in situ about the practices, thereby obtaining answers for questions such as “What are the most important aspects to notice?”, “What is being done?” and “How is it done?” One should avoid formulating questions using the word “should” (i.e. “How should this be done?”) or conditionals, such as “if” (i.e. “What should be done if . . . ” or “What would happen if . . . ”), for these words lead one out of the present practice and refer one back to the prescriptive dimension or to formal descriptions of the activity. In cases where talking during the activity is not possible or turns out to be insufficient, this can be done after the practice, trying to minimize the time elapsed between the observing of the practice and talking to the professionals.

“Self-confrontation” suggests that professionals must be confronted with their own practice. One way of doing this is to capture the activity on film and confront professionals with the resulting videos, stimulating them to answer to the same line of questioning concerning the decisions they made, the gestures and movements they performed, the elements towards which they turned their attention. With this tool, however, a greater level of detail is sought. An important question that might be raised at this time is “How did you learn this?, which allows for information to be gathered on the types of previous experiences that effectively contributed to the acquisition of a given ability. (Adapted from Clot, Y. Travail et pouvoir d'agir. Presses Universitaires France, 2008).

The “instruction of the double” (a tool, good especially in those cases where self-confrontation is difficult) consists of suggesting to the professional that he describe what is required so that a double—in this case, the analyst—can act as a substitute for him in his activity without being noticed. The intention here is the same one as in self-confrontation: to increase the degree of detail concerning the description of the practice and the means necessary for acquiring the necessary abilities to perform it (Adapted from Clot, Y. Travail et pouvoir d'agir. Presses Universitaires France, 2008).

To make activity analysis easier, the verbalizations amassed through these processes can also be transcribed, so as to allow the use of analysis and search engines.

The next step is the analysis of the data that was gathered, a moment in which attention must be directed toward several main points:

(i) Confrontation between prescribed and real activity (task versus practice);

(ii) Investigation of actions in their situated perspective. This allows for both in-depth (vertical) and horizontal understandings, reaching, respectively, the cognitive levels of decision-making and the dynamics involved;

(iii) Based on the previous items, the listing of judgments necessary for each meaningful operation of the activity analyzed.

Making of a Judgment Tree \textcircled{2}

From this point on, among the judgments listed, one must identify which depend on other, more basic judgments and which are pre-requisite for more complex judgments. This allows for hierarchical organization and the creation of a judgment tree \textcircled{2}.

While the extremities of the ramifications correspond to basic judgments, the nodes indicate the conjunction between them and the necessity of making a new judgment at a higher level of complexity. Thus, the higher the number of ramifications and/or other nodes below the judgment, the more complex it becomes. The easiest way to make a judgment tree is to start from the more complex judgments, and then to disentangle them into the subsequent judgments upon which they depend. This must be done in succession, until one reaches those judgments considered more basic or the level of detail aimed at for the training

Each judgment in the tree can be analyzed individually in relation to both types of tacit knowledge and types of judgment, so that the way of transferring it can be better understood. For instance, a judgment related to visual perception has somatic and collective counterparts. Identifying faults in a machine part depends on accuracy and visual training (somatic tacit knowledge), abilities that can only be acquired through practice, that is, through the attempt to identify faults in machine parts. However, to do this, it is necessary to have knowledge pertaining to patterns and working tolerances, so that one can judge what is or is not a fault and whether or not a given fault is acceptable (i.e. judgment of similarity/difference). This can only be acquired as the professional acquires collective tacit knowledge—that is, by socializing with people who already possess such knowledge.

From the point of view of judgment types, in that same example, we can observe the necessity of making judgments of similarity/difference. A basic requirement to learning this type of judgment is exposure to contrasts. If a novice does not see varied types of faults, located in diverse places in the part, with multiple intensities, he will not learn enough—thus, to store some parts with classical and distinct faults for reference constitutes a pedagogical tool.

In order for them to develop, judgments of relevance/irrelevance will require of the novices that they have access to the elements that underlie the experts' action, for instance, the prioritizing of actions and the establishing of pros and cons of the options. Judgments of risk/opportunity, by the same token, will require access to the elements necessary for the understanding of risks and identification of opportunities.

The considerations made about each judgment, as well as the judgment trees made, must be presented to the experts for validation and, when necessary, for adjustment. One should only proceed to the following steps when the judgment tree, in the opinion of the experts, reflects the real activity.

In short, visualizing the relationship between the meaningful judgments of a given activity in light of the types of both tacit knowledge and judgment allows for the establishment of more effective guidelines in providing novices with the necessary experiences. The judgment tree makes reflection and emphasis on such aspects easier. These normally are found to be implicit in the practices and are not adequately put into practice in the traditional on-the-job training formats.

In the following stages, judgment trees are used as tools within the technique presented here.

Introductory Training \textcircled{3}

After the making of judgment trees, an introductory training is to be organized. Its aim is to enable the experts and the other people involved in the novices' training to utilize the technique. A part of its content is the explanation of judgment trees and the providing of considerations on how to foster the learning of the different types of tacit knowledge and judgment.

After the introductory training, we proceed to the cycle comprised of the “Briefing”, “Guided OJT”, and “Debriefing” stages—each of which will be explained below—a well as the cycle between them. However, at this point, it is important to instruct the team about the creation of an environment that fosters learning.

Creation of a Learning Environment \textcircled{4}

The characteristics of a training environment interfere a great deal in the acquisition of complex abilities. Inspired by the ideas of authors Burton, Brown, and Fischer, this stage aims precisely at the creation of social conditions that facilitate the instruction process, with the making up of a “learning environment.” (Burton, R. R.; Brown, J. S.; Fisher, G. Skiing as a model of instruction. In: Rogoff, B. J.; Lave, J. (eds.) Everyday cognition. Cambridge: Harvard University Press, 1984, p. 140-149). For this purpose, more effective interactions must be fostered between experts and novices, and occurrences must be utilized that issue from the practice itself (namely, errors, problems, etc.) as important pedagogical and motivational resources. The convergence between these aspects must be modeled so as to provide beginners with elements related to the experience of contextual and situational aspects of activities. This dynamic, motivating, and above all, qualifying environment is thus christened social microworld.

More effective interactions between novices and experts first require the maximization of dialogue about the practices involved in an activity, and not simply about the activity's prescriptive dimension. Thus, novices require constant feedback from experts, be it before, during or after those practices.

Nevertheless, interactions are not restricted to dialogue. They may occur by means of gestures, of help in the execution of practices, and even in the correction of mistakes. This interaction in practice results in an opening up for the novice of an access road to values, meanings, and identity in the community of practice. This will allow him to recognize what is right or wrong, and adequate or inadequate within that given context (in other words, to develop collective tacit knowledge).

In the experts' dealings with mistakes made by novices, it is especially important that constructive corrections be made that do not simply point out the existence of errors nor adopt punitive postures. To deal with a mistake in a constructive way means utilizing it as a pedagogical resource, so the novice may learn from his own mistakes how to identify and correct them. (Burton, R. R.; Brown, J. S.; Fisher, G. Skiing as a model of instruction. In: Rogoff B. J.; Lave, J. (eds.) Everyday cognition. Cambridge: Harvard University Press, 1984, p. 140-149). The same can be said in relation to the novices' successes: a good performance by a novice must be emphasized, so that it becomes a reference for future attempts.

The very occurrences that emerge from the practice itself are the main points to be used in teaching, such as the novices' mistakes and successes, interferences that arise from circumstantial aspects of the practice and variations in the utilization of materials pertaining to the situation.

An environment that nurtures the novices' motivation also has its roots in the interaction between novices and experts and in good dialogue concerning the occurrences that come from the practice. Furthermore, it is necessary to notice whether or not the tasks suggested to the novices are on par with their levels of knowledge and ability. Assigning tasks that are too simple or too complex may end up discouraging apprentices.

For the purpose of creating these conditions (which are pre-requisites for all the subsequent phases), the first step is to choose a given judgment to be dealt with during practices—or more than one, if possible. This will allow the expert to focus his efforts and the novice to focus his attention, allowing for a stronger guidance of the work and a maximization of the aforementioned aspects.

The choice of target judgments must be on par with the novices' skill levels. The number of judgments, on the other hand, depends on the characteristics of the practice and the degree of difficulty in making them.

Briefing \textcircled{5}

Briefing is a military term for describing the moment when a troop receives instructions before executing a mission. Within this process, lies a step in which the experts are to gather with the novices before the operation, in order to define the target judgment(s) and to provide instructions about the significant points of attention, the best way to perceive them, what is involved and entailed in these points, etc. Whenever possible, information should also be provided about the context of the operation and on how it may interfere with the points of attention.

At this stage, judgment trees can be used to assist in the novices' understanding, especially when the chosen judgments depend on judgments that were previously learned.

Guided On-The-job Training (G-OJT) \textcircled{6}

When the Briefing step is completed, the novices are to practice the chosen judgments, overseen in their performance by the expert. During this practice, novices should be instructed as much as possible to perceive the points of attention that are necessary for those judgments and that were made evident on the previous stage.

This can be accomplished through a guiding of instructions, a raising of questions, and the occasioning of new experiences to the novice, according to the type of judgment chosen and the tacit knowledge involved in the operation. For instance, if the judgment chosen is one of similarity/difference, the expert must emphasize contrasts between distinct situations, whether they are present during the very same practice or recalled from previous practices. If the operation depends largely on somatic tacit knowledge, the expert must give novices a chance to execute enough repetitions so they can learn the bodily counterpart.

In traditional on-the-job training, learning takes place almost at random, according to what the activity's environment offers. In contrast, guided on-the-job training—which is founded upon judgment trees and on the types of judgment and tacit knowledge—allows us to direct novices, during practices, towards the necessary experiences.

A tool that can be used in support of Guided OJT is the creation of “microworlds of increasing complexity,” which are referred to, here, simply as “physical microworlds,” to distinguish them from the “social microworld” previously discussed. (Burton, R. R.; Brown, J. S.; Fischer, G. Skiing as a model of instruction. In: Rogoff, B. J.; Lave, J. (eds.) Everyday cognition. Cambridge: Harvard University Press, 1984, p. 140-149)

The creation of a physical microworld consists of the elaboration of a context that “provides the student with a task he can successfully accomplish by employing a simplified version of the final ability to be acquired” (p. 139). These microworlds are then progressively modified so as to make tasks gradually more complex, to the point where the student can perform the integral task in a competent way.

These modifications can be done through the manipulation of three basic elements: the equipment utilized to execute the task, the configurations of the physical environment in which the task is executed and the specifications of the task. When manipulating those elements, it is important, in the first place, to make sure that simplified ability is isomorphic in relation to the final form of the ability in relation to its main components. It is also necessary to make certain that the ability will not be oversimplified, which would otherwise render the microworld too friendly and suppress the apprentice's development and his future capability of dealing with contingent contexts. Finally, linear programs should be avoided, for they can facilitate an attitude of accommodation in apprentices, as well as the development of a resistance towards less friendly environments and strategies to avoid mistakes which are incompatible with the final version of the ability. (Burton, R. R.; Brown, J. S.; Fischer, G. Skiing as a model of instruction. In: Rogoff, B. J.; Lave, J. (eds.) Everyday cognition. Cambridge: Harvard University Press, 1984, p. 140-149.)

These manipulations allow the novice to focus on factors that are fundamental for learning the ability, instead of on those which are not immediately relevant. Therefore, just as it is possible to create a “social microworld” that provides a social environment adequate to learning and to accessing values, meanings and identity in the group, so a “physical microworld” can be created that allows the apprentice to have the appropriate experiences for his stage in the process of learning.

Debriefing \textcircled{7}

Also having its origins in military language, the term Debriefing suggests a moment for assessment after the execution of a mission. Accordingly to this idea, in this stage, the novices' performance during the Guided OJT must be evaluated by experts, who will provide, in their turn, the necessary feedback. The benefit of Debriefing is the creation of moments external to the practice—or even internal to it, whenever possible, through pauses—for discussing the novices' performances.

At this point, it is important to stress the novices' successes, thus consolidating what can be considered as competent performance, and to deal with occasional errors in a constructive way, by using the mistakes made by novices as pedagogical resources for teaching the performance held as correct.

Repetition and Feedback of Stages 5, 6, and 7 \textcircled{8}

In order for a novice to learn the chosen judgment, normally it is necessary for him or her to practice the activity several times straight, and get, each time, the feedback required for his performance to progressively improve. For that reason, stages 5, 6, and 7 should be repeated, for each chosen judgment, until the novice attains a level the expert considers to be sufficient through his or her assessment.

Each cycle will allow the novice to obtain new guidelines for the adequate execution of the practice and going progressively higher on the judgment tree. Experts might opt for developing parallel cycles with different judgments, or even to repeat cycles for a single judgment until it has been learned.

Let us stress the fact that, when beginning a cycle for a more complex judgment, it is important to keep in mind that the judgments present in the inferior levels should already have been learned—except in special cases where they can be overlooked.

The Training Technique for Transferring and Developing Tacit Knowledge consists of practical means for speeding up the transfer of tacit knowledge between experts and novices and for enabling novices to make correct judgments.

### Example 1

### An Application of the Technique in a Metallurgical Plant

The 4T system was applied to the learning process of metal operators of a furnace in a metallurgical plant located in the north of Brazil. Although several training initiatives had been undertaken by the company and a great amount of time had been spent on preparing the novices for the work, the experts still considered novices to be unprepared. In addition to that, the unsuccessful relationships between novices and experts were often attributed by the experts to character flaws and lack of interest of novices.

Both the novices' unsatisfactory performances and this psychologization of people and work relations may be consequences of the manner in which the company's training program is carried out. Based on a traditional system of OJT, their training favors practice without, however, guiding novices' experiences or creating mechanisms for facilitating learning.

In the following section, the implementation of the technique here described in the case at hand is detailed, putting in relief the actions executed at each one of its steps.

### Example 2

### Training Technique for Transferring and Developing Tacit Knowledge Analysis of the Activity \textcircled{1}

The main function of a metal operator is to perform the metal tapping. This activity consists of getting molten metal out from an electric furnace into a ladle where the cast volume of metal will thence proceed to be refined. This is carried out by opening the taphole which leads the material out into a ladle. This activity, in short, can be divided into five basic steps: i) preparation of the activity; ii) drilling and tapping; iii) oversight of the tapping; iv) plugging; and v) organization of the area.

During the preparation for the activity (i), the metal operators check the general conditions of the area, the equipment and of the input necessary for metal tapping. On the drilling and tapping stage (ii), the taphole is pierced with a hydraulic drilling-hammer, but only until the solidified metal layer in the inner part of the furnace is reached. Then, the solidified metal is pierced with a type of blowtorch—called an oxygen lance—until the liquid is reached and begins to run out of the furnace. The oversight of the heat (iii)—a name given by metal operators to the ongoing tapping of liquid metal (“This heat's content is good”) or to the result of this process (“Lots of slag came out from the heat number 74”)—consists basically of controlling the flow and checking the conditions of the tap and the volume tapped. During this stage, sampling procedures for the cast and procedures of temperature measurement are also carried out. Plugging (iv) is done when the volume of the cast in the ladle reaches the required amount, or when there are risks that cannot be mitigated. For plugging, it is necessary to remove the solidified cast bodies—called “scraps”—that form close to the taphole, and, next, to activate a furnace gun that injects refracting sealing compound so the taphole is sealed anew. After this stage, the area must be organized again (v): the tap must be repaired, the input must be restituted, and the tools must be put away, so that the area is left as ready as possible for the next tapping. Before this training program was implemented, there would normally be one to three heats per day.

In order to understand the above activities, the analyst gathered all formal material pertaining to it, such as SOPs, heat-control spreadsheets, checklists, etc., and to the team, such as legal and normative pre-requisites concerning this work, training programs in which workers had taken part, as well as their technical curricula.

Concomitantly, non-structured interviews were made with the metal operators and other people involved in these activities, such as engineers and supervisors. Metal operators were asked additional questions about their previous experiences and the extent to which they resembled the current context, so as to get an initial grasp on how they acquired their expertise. Those interviews were recorded and transcribed.

Added to the free oversight of metal tapping and of other moments related to it—such as meetings, analysis of faults, and SOP update campaigns—these initiatives produced a period of acclimation which aided the better guidance of subsequent stages. All the material amassed and produced was then organized, thus allowing for a global view of the activity, although only still in its prescriptive (formal) dimension.

For the guided overseeing of activities, the analyst sought contact with the experts, questioning them on what they did and what had led them to do that job and how they performed it. However, as communication during metal tapping is difficult due to the high level of noise, to the use of PPE [personal protective equipment] on the face, and to the intense moving around of the metal operators, approach during that activity was sometimes impossible or resulted only in superficial answers. For that reason, a post-practice approach was used, with minimal intervals of time between observation of practice and interaction. In order to maximize this moment, some instances of metal tapping were recorded, and the resulting videos were shown in the self-confrontations.

During self-confrontations, an even greater level of detail concerning the metal operators' expertise was sought, according to perspectives of horizontality and verticality. The horizontal dimension, which refers to the point of view of the dynamics of the action, allowed for an understanding of the factors leading the operator to focus on certain elements or to intervene in a certain way during the activity. The vertical dimension, in turn, which takes the point of view of depth, allowed for the understanding of what was important to the operator when he was looking at a given point or intervening in a certain manner. This was the moment when more information was obtained pertaining to the necessary judgments.

Also, by means of the self-confrontations, an attempt was made to understand the experts' learning process more profoundly. Metal operators were asked on how they came to learn each of the abilities identified during the self-confrontations. This allowed for a better understanding of which experiences were necessary for a novice to have.

The instruction of the double was also employed. As the plant where the training was conducted was on its ramp-up stage (start-up of the operations), the process was interrupted several times due to the necessity of the execution of maintenance procedures. Some of these interruptions lasted for approximately two weeks. During these periods, metal operators were idle or performed activities that normally did not pertain to their job descriptions. Since just talking to them could result in providing elements that were too prescriptive due to distance from the activity, the instruction of the double was a useful resource during these intervals.

All self-confrontations and instructions of doubles were recorded; some were entirely transcribed, while others only selectively.

Making of the Judgment Tree \textcircled{2}

Using the information obtained from analyzing the activity, judgment trees were drawn concerning those judgments considered to be more complex and hard to acquire. That choice was made collaboratively by the experts and the analyst.

Among the judgments that were selected, two of the most complex ones refer to the removal of “scrap” before the plugging. Whenever metal is tapped, a formation, close to the taphole, always occurs from the bodies of solidified material. It must be removed so that the equipment that plugs the taphole through which the metal flows can have direct contact with the launder, thereby plugging it. If the “scrap” is not adequately removed, there is a risk that the furnace gun will inject its material in the outer part of the taphole, thus failing to plug it and rendering the metal tapping uncontrollable. For this reason, this operation is considered to be the most critical one in all of the ones performed during metal tapping.

Scraps can have different sizes, weights, and strengths, depending on the length, the flow, and the content of the heat. According to its characteristics, it may need to be split into smaller pieces in order to be removed or to retain its molten surface. This activity may be divided into two distinct moments: the choice of intervening for removing a scrap and its subsequent application. Among the forms of intervention, metal operators may opt to use the oxygen lance to produce “cuts,” splitting a scrap into pieces by means of fusion; to break it using either the movements of a lever or simply levering it out or to combine the oxygen lance with the lever. Next, the whole scrap or its pieces are taken out by the team: the metal operators situated to the left of the tap push them with levers, while the ones to the right pull them with hooks.

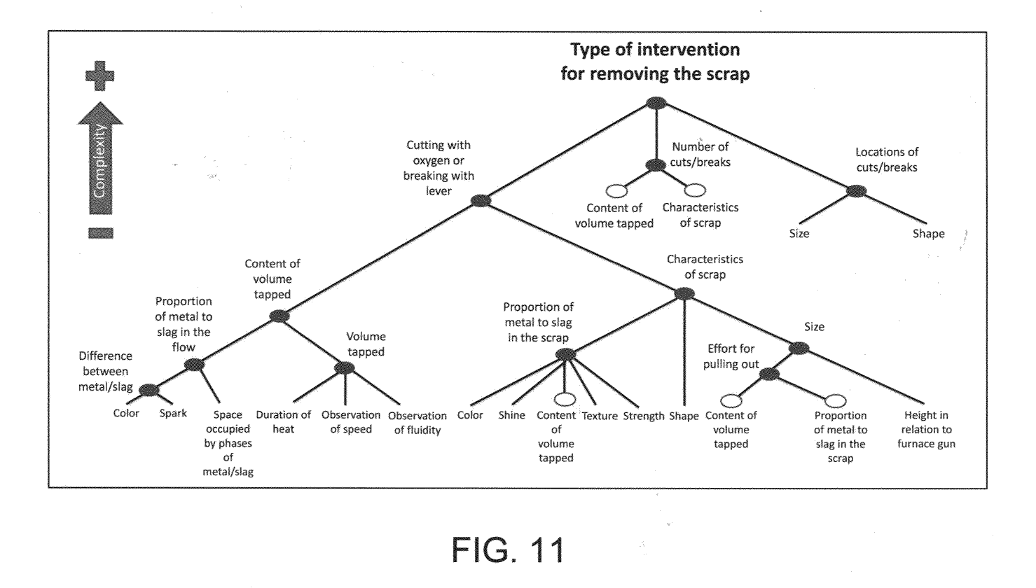

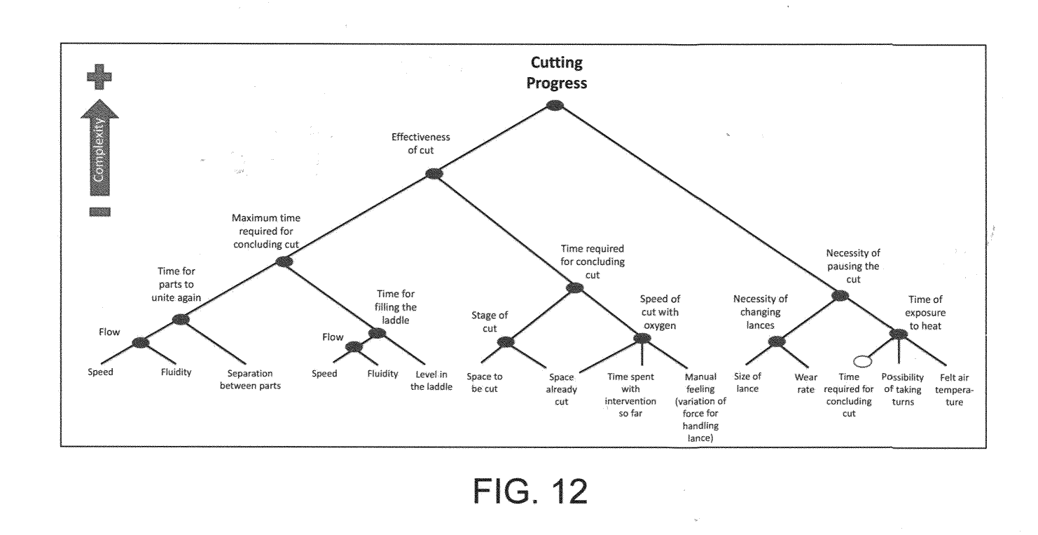

Judgment trees were made for the choice pertaining to the “Type of Intervention for Removing the Scrap” (FIG. 11) and for the “Oversight of the Cut” (FIG. 12) when the intervention chosen was the oxygen lance. These make it possible to illustrate the phenomenon underlying the drawing of each node.

To the left of the “Type of Intervention for Removing the Scrap” tree (FIG. 11), one can find the judgment concerning the “content of volume tapped”. Due to the ramp up phase, there often was the presence of slag in the flowing of the liquid metal. Being able to identify the slag and to distinguish it from metal was therefore an important judgment, essential to many tapping operations. However, distinguishing one element from another in the flow of molten material is not a simple task. This can be illustrated by the verbalization made by one of the novices when giving an account of his first attempts: “I looked [at the flowing of the liquid] and saw only metal. I only saw fire there.”

By means of the self-confrontations, it was observed that, in the first moments of the metal tapping, there are two main criteria for distinguishing between the phases of metal and slag: the presence of sparks that are typical to the metal and the difference in color between it and the slag. When these sparks are identified, then one knows that what he or she sees is metal. Otherwise, it is only slag and, therefore, the tapping must necessarily be interrupted. This was illustrated by the account given by one of the experts, “The metal, [ . . . ] it makes some tiny sparks. The slag does not. The slag runs smoothly.” Thus, the absence of sparks, meaning also the absence of metal, would be enough already for one to make a judgment on the “content of volume tapped.” However, when there is both metal and slag in the flow, there will also be sparks. In this case, the slag must be identified by its visual aspect, designated by experts using the term “color”. As the metal operators tell us, they are capable of identifying the “color” of slag, because it is “lighter,” “yellower,” “shinier, while the metal is darker.” Their trained eyes can see this contrast which is imperceptible to people who are not accustomed to the activity, as was the case of the analyst at the beginning of the research.

After being able to notice the difference in color, the next step is the estimation of the proportion of slag to metal in the jet of molten metal that flows from the taphole. This conclusion emerges from a notion about the space occupied by the phases in the flow. Metal operators express this proportion in terms of percentiles: “There is about 25 to 30 percent of slag in this flow. The rest is metal;” or in expressions such as: “pure metal,” “very little slag,” “a lot of slag,” “too much slag.” Based on this quantification and on the experience of several tappings, metal operators are able to foresee many characteristics of the metal tapping simply by visually observing the initial flow.

The association between the proportion and the “volume tapped” allows the operator to make inferences about the “content of volume tapped” up to that point. The volume tapped, as it is understood by operators, does not refer precisely to the physical volume of the metal (which, in this case, would be related to the level reached within the ladle), but to a notion that comes from variations in the profile of outflow of molten metal (“oversight of speed”—the speed of the flow—associated to the “oversight of fluidity”—namely, how much the flow has drained or been retained throughout the taphole) over the “time of tapping.” This sort of “intuitive calculation” that issues from the time elapsed in tapping, the speed of the flow, and the fluidity of the metal is done by the operator when overseeing the tapping.

It is important to stress that the characteristics of the metal tapping and the solidifications throughout the tap also contributed to the understanding the proportion of metal to slag, and, therefore, to the judgment concerning the “content of volume tapped.” Slag is solidified faster; it produces bubbles when flowing—“like boiling milk,” as one operator explained it—elevates the felt air temperature, and produces smoother, darker and more brittle scraps. Metal, on the other hand, flows more smoothly, makes the typical sparks and produces scraps whose shine is less intense but more lasting than that of the slag scraps. Thus, the process of metal tapping also conveys information that is used in real time by metal operators.

The same judgment, on the “content of volume tapped,” is also be present in three different points in the tree: below the judgment on “Number of Cuts/Breaks,” below the judgment through which the metal operator estimates the “Effort [to be spent] in Pulling Out” the scrap, and below the judgment on “Specifications of the Scrap” (the open circles on FIG. 11 are used to avoid redundancies, and indicate judgments that are present in the same tree and that have been previously detailed. The judgment on the content of volume tapped, for instance, is only detailed on the left side of FIG. 11, although it arises in three other points in the tree).

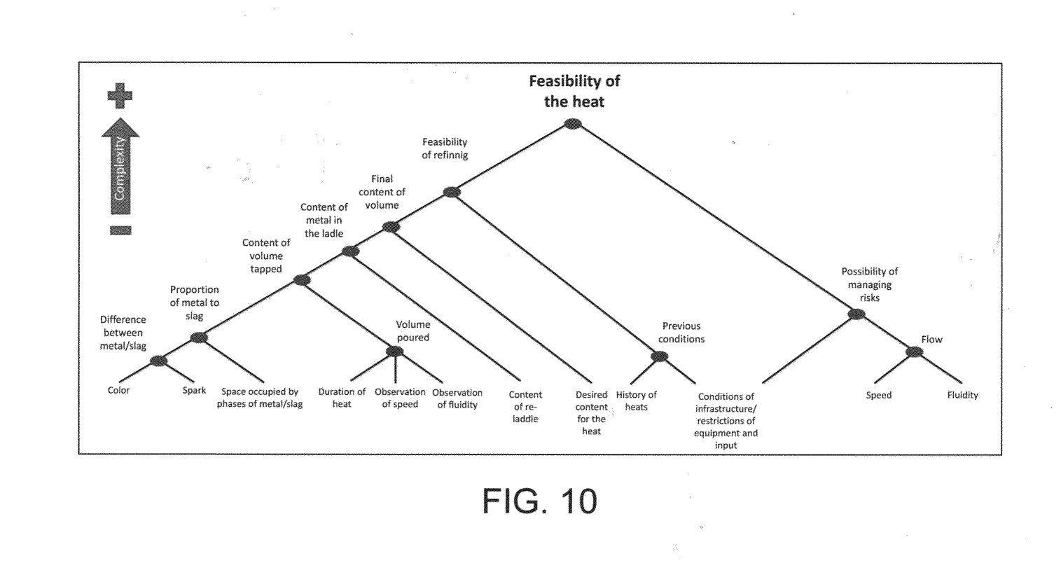

It is important to notice that the judgment on the content of volume tapped was also present in other trees made for the activity (see FIG. 10), which means that several basic judgments may be common to several different operations. This helps us to understand metal operators' aptitude for foresight when looking at the flow of the cast. Since the elements to which they direct their attention have implications for the whole activity of pouring, their characteristics allow operators to foresee, up to a certain point, what will happen during the process. Changes and unexpected events are also common at the points of judgment; however, as the configuration of the tapping changes, the constant observation of the flow allows operators to always have an updated judgment on the content of volume poured at hand.

A similar case happened with the judgment on the “Specification of the scrap,” which bears implications for two of the judgments mentioned in FIG. 11: “cutting with oxygen or breaking with a lever” and “number of cuts/breaks.” A scrap that is composed only of slag is fragile, light and brittle, but the oxygen lance cannot cut it. In such a situation, a lever would be used to break it. A scrap composed only of metal, on the other hand, is heavy, rigid and strong, but it can be cut with an oxygen lance. The lever, when it is applied against a metal scrap, however, may bend and fail to produce good results.

Still, slag and metal may blend and produce hybrid scraps, so that some of these characteristics will commingle. There can be, for instance, scraps whose surface is made only of slag, but whose core is metal. So, if a metal operator tries to lever it out, it is unlikely that he or she will get any results. He or she would then need to use the lever to break the surface of the scrap and the oxygen lance to cut its inner part. Nevertheless, if the layer of slag is thin, or if metal and slag are mixed in its composition, the oxygen lance alone might suffice. If the cut reaches the metal, thus making the scrap frail, the layer of slag may break when operators try to lever it out.

Based on the scrap's appearance (color, glow and texture) and strength (which may be tested with blows of the lever), the metal operators can observe several of its characteristics. It is not enough, however, in order to choose the best means of intervening, for the operator simply to take a look at it by the end of the tapping. He or she must understand the content of volume poured during the tapping so as to know what the constitution of the scrap is. Due to the variation in proportion of metal to slag, over the analysis of the activity, situations were observed where only one means of intervention was employed, or where both the lever and the oxygen lance were required. For the latter, the choice depended on the constitution of the outer layer: if it was made of metal, the oxygen lance was used; if made of slag, the lever was used.

Choosing the correct means of intervention is important to the operators, for the plugging normally occurs when the ladle is almost full. Thus, choosing the wrong kind of intervention may waste time and the metal may not be prevented from leaking out. For this reason, it is important that the metal operator also make his or her intervention quickly and efficiently. If he or she takes too long to cut or break the scrap, besides risking overexposure to the heat, the flow of cast may also “glue” back together the parts that were previously split. The cutting/breaking of the scrap is when these professionals get closer to the taphole. An operator that is accustomed to high temperatures can only stay in this position for about a minute. If the intervention takes too long, taking turns might be necessary. This, however, takes longer, and so may compromise the removal of the scrap.

In FIG. 12 the judgment tree concerning the “cutting progress” is represented. Unlike the other tree examples we have used so far, which have favored actions related to visual perception, this tree refers to judgments made over the course of a motor action: using the oxygen lance. Two points of attention that stand out for this reason are those that pertain to the “manual feeling” and the “felt air temperature.”

Experienced metal operators are able to “feel” whether the cut is progressing or not. Based on this feeling, they can adjust their movements so as to get better directions and greater speed in the operation. One of the experts, for instance, would often strike the tip of the lance against the scrap. This movement helped in making way through the layer of slag for the flames to reach the metal below. This would only work, however, when this layer was not too thick. He would only do that after feeling that the cut was not progressing well; noticing the presence of slag, he would choose to take subtle blows so as to break it. Sometimes, however, when this was not enough, it was necessary to hit the scrap with a lever.

Managing the duration of exposure to heat, in this process, was also extremely important. The clothes worn by the metal operators have a foil layer to minimize the absorption of heat radiated; nevertheless, not all of the heat is deflected. Because they are made of a thick material, when heated, these outfits require a certain amount of time to cool off. If an operator gets “too hot,” he will need to get away from the taphole and wait for a while, passing the oxygen lance on to another operator. But these few seconds may be enough for the parts of the scrap to fuse together again, as has been previously mentioned. So it falls upon operators to be as efficient as possible in the cutting operation and also in taking turns. Often, seeing that a significant amount of time has passed during the operation of cutting, an operator that is not doing the cutting will touch the back of the operator handling the oxygen lance, signaling that he is ready to take over should it become necessary. However, there is not always someone available to do so, especially when dealing with a small team. When this happens, the person responsible for the cutting must avoid exposure to heat for a moment before the plugging, so as to be able to endure longer, should the operation require this. Also, for this same reason, novices would not cut scraps when there was not an expert available to help them.

After these considerations, it is possible to understand just how complex the chosen judgments are. The task of teaching them, likewise, is not simple at all, especially taking into consideration that experts simply do not verbalize most of the details revealed by the analysis of the activity. It only remains to be seen whether the interpretation made by the analyst concerning the activity accurately describes reality. For this purpose, the judgment trees and the considerations pertaining to all the points that were identified were presented to every one of the experts.

The following verbalizations express the experts' favorable opinions about the interpretation and analysis of the activity made by the analyst. The first one refers to the analysis as a whole, and the second to the judgment trees:
(i) “Your type of sincerity, that you used with us, that you got nothing more, and nothing less. You got an experience with what is happening in the area.” (Expert)
(ii) “To make a graph like this one [i.e. the judgment tree] you did as well, like, not even I, someone who has been tapping metal for so long, would be able to make. To show it point by point.” (Expert)

In short, judgment trees could be made for the different operations carried out by metal operators, comprising points of attention that require somatic and collective tacit knowledge and situational understanding.

Introductory Training \textcircled{3}

The introductory training was administered to the experts and the team supervisor by the analyst. During this training, the concepts of the types of tacit knowledge, the types of judgment and the learning environment were introduced. Each step to be implemented was also explained, and the judgment trees chosen for the intervention where shown.

Creation of the Learning Environment \textcircled{4}

The premises for the creation of a learning environment that were clarified in the description of the process can only be used with the help of the team. For this reason, its formal construction and maintenance begin when the introductory training starts, once everyone is made aware of its necessity. Throughout the following steps, these premises provide a basis for the initiatives taken by the analyst and guide the experts' interventions.

Briefing \textcircled{5}

In this and the following steps, the actual implementation of the technique will be illustrated by means of the actions undertaken for the tree concerning the “type of intervention for removing the scrap” (see FIG. 11).

When the time for intervention came, novices were already able to make most of the judgments involved in choosing the best type of intervention. However, their judgments did not always lead them to the most adequate choice. For this reason, the “briefing” was focused on the three nodes immediately below the main judgment: “cutting with oxygen or breaking with lever,” “number of cuts/breaks,” and “location of cuts/breaks.”

During this step, the expert in each group commented on each one of those nodes, on what was involved in each, and, taking into consideration the profile and operational history of the furnace over the previous few days, what could be expected from the next heat. They also talked about the most common mistakes made by novices in the previous tappings as regards judgments chosen, providing types for correcting these mistakes.

Guided On-The-job Training (G-OJT) \textcircled{6}

For the Guided OJT, the activity's analyst suggested an exercise based on the notion of a “physical microworld.” The expert and every one of the novices, before starting the procedure for removing the scrap, would write down on a piece of paper the intervention of their choice and the number and location of cuts/breaks.

When the moment came to plug the taphole, the metal operators filled out their sheets of paper, based on the observed tapping, which were then collected by the analyst. In this way, novices were able to make less complex judgments than the final judgment, in a less risky environment in which everyone could take part.

This initiative allowed for an explanation of what the novice would do even if he or she was not the one to cut the scrap on that day. Thus, instead of training just one novice per tapping, all of them got the chance to manifest and receive an assessment on their respective choices in each and every one of these occasions.

Due to this exercise, the existence of inadequate judgments, aside from not resulting in mistakes with grave consequences, could also be discussed a posteriori. This strategy was used over a couple of tappings, and the sheets of paper that were filled out would always be brought in for discussion during the following stage.

Debriefing \textcircled{7}

In this stage, the elements that interfered with judgments chosen over the course of a tapping were discussed, as well as their implications for the decision concerning which was (or should have been) the most appropriate intervention. For this purpose, the judgment tree was resorted to once again, so as to increase explanatory potential.

The sheets of paper filled out by novices were confronted with those filled out by the expert. Where there were discrepancies between them, the novices had to give the reason for their answers. The experts were thereby able to understand the cause for the discrepancy, so that they could provide guided feedback and, thus, deal with mistakes in a constructive manner. Where there were no discrepancies, the experts merely stressed the aspects that interfered with their decision.

During “Debriefing,” though the experts' words had primacy, the environment was one of an open atmosphere where novices could make contributions, ask questions, and make all the comments they wanted, whenever they wanted to do so.

Repetition and Feedback from Stages 5, 6, and 7 \textcircled{8}

As suggested by the explanation of the technique, the cycle made up of the stages of Briefing, Guided OJT and Debriefing was repeated time and again.

By the end of the last repetition, all the participants' opinions concerning the stages of the technique were sought. Below are several meaningful verbalizations made by both novices and experts. Among them, some (i, ii, and iii) refer to the process as a whole, while others (iv, v, and vi) refer to the learning environment created for the stages and implemented by means of them, and the last one (vii) refers to overcoming the problem of divergent salience.
(i) “For even we that have all this experience, all this time on the road, sometimes are far from what one might wish regarding what appeared or did not appear. Because sometimes we lack that attention of talking with them as it was explained in this training. [ . . . ] And when things are shown on paper, as they were here, showing all the graphs, the person will do the job more attentively than when you go and show him how it's done.” (Expert) (He used the term “graphs” to refer to the judgment trees. The same is true for verbalization “vi”).
(ii) “I learned a lot from the practice, but from the theory, from the theoretical part you taught us, during the practice we would remember what we had read. Like the tree nodes, which we would try to decipher. It was very important to me.” (Novice) (He used the terms “theory” and “practice” to refer to the stages of Briefing and Debriefing, and to the judgment trees).
(iii) “[Had we implemented the process from the beginning] the difference would have been huge. Because, with this, you can see a lot of stuff . . . before the practice. So the person already goes with more attention to carry out the activity.” (Novice).
(iv) “We are talking now. During the tapping, we now are talking—how the heat is going on, whether there is a lot of slag or not, how the scrap is. Before, we did not used to talk like this. We talked like this: ‘The heat is very bad,” but not like this: ‘because . . . the reason why this heat is bad, what can be done to improve it’.” (Novice).
(v) “What you suggested, for us to interact more with each other, that was a lot better for us than just taking it upon ourselves to explain things to novices.” (Expert).
(vi) “After you showed this stuff to novices, and made this graph, they begun paying more attention to things. They listen more, if they do something wrong they come looking for me, and before they did not. It happened that, after this stuff, now they want to know everything right, how things are.” (Expert).
(vii) “The guy who is just getting started, and I′m in this situation, he will go through this before, it's going to be very important for him, because he will see in practice what he has seen in theory, he will have lots more questions to ask his superior. I read this, and this, and that in the training . . . what is the difference there? He will be able to formulate a good question for the expert at the time, for the superior who is teaching him.” (Novice).

In short, it has been verified that the content and quality of the 4T system attained the objective of fostering—in a systematic and unprecedented manner—the development of the types of tacit knowledge and of the judgments involved in the activities chosen.

In regards to the shortening of the length of training, suffice it to say that, after observing 20 tappings and making the chosen “judgment trees,” the analyst—a novice himself—was able to make several judgments that novices who had already taken part in more than 60 tappings were not able to make. Furthermore, the analyst was also able to identify mistakes made by novices, and was even able to avoid a potential accident concerning the inadequate handling of the oxygen lance.

### V. Conclusion

Example embodiments have been described above. Those skilled in the art will understand that changes and modifications can be made to the described embodiments without departing from the true scope and spirit of the present invention, which is defined by the claims.

1. A method for Tacit Knowledge Management according to Levels of Similarity, the method comprising:
identifying, in terms of tacit knowledge, the specificities of each function within a project;
identifying the work collectives existing in a project;
planning the work collectives with an adequate mix of professionals so as to guarantee the presence of tacit knowledge in each group and optimize its transfer; and
identifying gaps in the tacit knowledge existing in each group, thereby making possible the taking of corrective action.

2. A method for Tacit Knowledge Management according to Levels of Similarity, according to claim 1, further comprising:
developing a system for hiring professionals based on the analysis of candidates' tacit knowledge; and
calculating the tacit knowledge contribution necessary for the project and/or other specific areas.

3. A method for Tacit Knowledge Management according to Levels of Similarity, according to claim 1, characterized by stages that can be monitored, so the system can receive information feedback, thereby making it possible for managers to act towards the reorganization of groups and the selection and hiring systems, as well as the attraction and retention of people with high similarity level.

4. A method for Tacit Knowledge Management according to Levels of Immersion, the method comprising:
identifying gaps in training systems as regards their contribution towards tacit knowledge transfer, making it possible for corrective action to be taken;
identifying and developing types of training that are more adequate for certain strategic functions, based on their specificities; and
planning and assembling optimized training systems and directed specifically towards the development of the different levels of trainees as regards tacit knowledge.

5. A method for Tacit Knowledge Management according to Levels of Immersion, according to claim 4, further comprising:
developing a system for hiring training programs based on their contribution towards tacit knowledge transfer.

6. A method for Tacit Knowledge Management according to Levels of Immersion, according to claim 4, characterized by stages that can be monitored, so the system can receive information feedback, thereby making it possible for managers to act towards the reorganization of groups and the selection and hiring processes, focusing on the development of the team's tacit knowledge.

7. A method for Tacit Knowledge Management according to Levels of Similarity and Levels of Immersion, according to any one of claim 1-6 or 12-13, characterized by practical means for making Tacit Knowledge Management operational.

8. A Training Technique for Transferring and Developing Tacit Knowledge, comprising the following stages:
a) Analysis of the activity;
b) Making of the judgment tree;
c) Introductory training;
d) Briefing;
e) Guided On-the-job Training (G-OJT);
f) Debriefing; and,
g) Repetition and feedback of the Briefing stage, the Guided On-the-job Training stage, and the Debriefing stage.

9. A Training Technique for Transferring and Developing Tacit Knowledge, according to claim 8, further comprising:
an additional stage concerning the creation of a “learning environment” by means of physical and social microworlds, characterized by establishing a learning environment that foster interaction between experts and novices, and for being undertaken before the Briefing stage.

10. A Training Technique for Transferring and Developing Tacit Knowledge, according to claim 8, characterized by the analysis of activity stage, which contains the following steps:
a) gathering of related documents;
b) overseeing of practices;
c) guided overseeing of activities;
d) self-confrontation;
e) instruction of the double;
f) confrontation between prescribed and real activity;
g) investigation of actions in situated perspective; and,
h) listing of required judgments.

11. A Training Technique for Transferring and Developing Tacit Knowledge, according to any one of claim 8, 9, and 10, creates a practical means for accelerating the transfer of tacit knowledge and of the ability to make correct judgments between experts and novices.

12. A method for Tacit Knowledge Management according to Levels of Similarity, according to claim 2, characterized by stages that can be monitored, so the system can receive information feedback, thereby making it possible for managers to act towards the reorganization of groups and the selection and hiring systems, as well as the attraction and retention of people with high similarity level.

13. A method for Tacit Knowledge Management according to Levels of Immersion, according to claim 5, characterized by stages that can be monitored, so the system can receive information feedback, thereby making it possible for managers to act towards the reorganization of groups and the selection and hiring processes, focusing on the development of the team's tacit knowledge.
